(19) United States
(12) Patent Application Publication
(10) Pub. No.: US 2017/0215117 A1
(43) Pub. Date: Jul. 27, 2017

(54) METHOD AND APPARATUS FOR HANDOVER IN WIRELESS COMMUNICATION SYSTEM USING BEAMFORMING

(71) Applicant: Samsung Electronics Co., Ltd., Suwon-si Gyeonggi-do (KR)

(72) Inventors: Sang-Wook KWON, Yongin-si (KR); Sang-Kyu BAEK, Yongin-si (KR); Young-Bin CHANG, Anyang-si (KR); Hyun-Jeong KANG, Seoul (KR)

(21) Appl. No.: 15/324,992

(22) PCT Filed: Apr. 7, 2016
(86) PCT No.: PCT/KR2016/003672

§ 371 Date: Jan. 9, 2017

Related U.S. Application Data
(60) Provisional application No. 62/143,920, filed on Apr. 7, 2015.
(60) Provisional application No. 62/145,117, filed on Apr. 9, 2015.

(51) Int. Cl. H04W 36/00; H04L 5/00; H04W 36/32; H04B 7/06

(52) U.S. Cl. CPC H04W 36/0094; H04B 7/0617; H04L 5/0051; H04W 36/32; H04W 74/0833

(57) ABSTRACT

An apparatus and a method for a handover in a communication system using beamforming are provided. The method includes the operations of receiving handover information from a serving base station, measuring, on the basis of beam scanning, a first reference signal transmitted from the serving base station and a second reference signal transmitted from a target base station, if the result of the measurement satisfies handover conditions, transmitting the result of the measurement to the serving base station, and receiving, on the basis of the handover information, a handover permission message from the target base station.

### CROSS-REFERENCE TO RELATED APPLICATION(S)

This application is a U.S. National Stage application under 35 U.S.C. §371 of an International application filed on Apr. 7, 2016 and assigned application number PCT/KR2016/003672, which claimed the benefit of a U.S. Provisional application filed on Apr. 7, 2015 in the U.S. Patent and Trademark Office and assigned Ser. No. 62/143,920, and of a U.S. Provisional application filed on Apr. 9, 2015 in the U.S. Patent and Trademark Office and assigned Ser. No. 62/145,117, the entire disclosure of each of which is hereby incorporated by reference.

### TECHNICAL FIELD

The present disclosure relates to method and apparatus for handover in wireless communication system using beamforming.

### BACKGROUND

In order to meet the demand for wireless data traffic soring since the 4^{th} generation (4G) communication system came to the market, there are ongoing efforts to develop enhanced 5^{th} generation (5G) communication systems or pre-5G communication systems. For the reasons, the 5G communication system or pre-5G communication system is called the beyond 4G network communication system or post long-term evolution (LTE) system.

For higher data transmit rates, 5G communication systems are considered to be implemented on ultra-high frequency bands (mmWave), such as, e.g., 60 GHz. To mitigate path loss on the ultra-high frequency band and increase the reach of radio waves, the following techniques are taken into account for the 5G communication system, beamforming, massive multi-input multi-output (MIMO), full dimensional MIMO (FD-MIMO), array antenna, analog beamforming, and large scale antenna.

In addition, various technologies are being developed for the 5G communication system to have an enhanced network, such as evolved or advanced small cell, cloud radio access network (cloud RAN), ultra-dense network, device-to-device (D2D) communication, wireless backhaul, moving network, cooperative communication, coordinated multi-point (CoMP), and interference cancellation.

There are also other various schemes under development for the 5G system including, e.g., hybrid frequency shift keying (FSK) and quadrature amplitude modulation (QAM) modulation (FQAM) and sliding window superposition coding (SWSC), which are advanced coding modulation (ACM) schemes, and filter bank multi-carrier (FBMC), non-orthogonal multiple access (NOMA) and sparse code multiple access (SCMA), which are advanced access schemes.

Advent of smartphones or so led to an exponential increase in user data, i.e., data usage, and the demand for a high data throughput per user is increasing more and more. This immediately means the need for a higher bandwidth for which use of a higher frequency is required.

However, the higher frequency is used, the higher per-distance signal attenuation appears. In other words, the use of a center frequency which is 30 GHz or higher renders it difficult to avoid a reduction in coverage by a base station due to signal attenuation. A higher frequency, by its nature, leads to a poor transmission. Thus, if a terminal moves from a line-of-sight area between the terminal and a base station to a non-line-of-sight area, the signal strength of the terminal sharply attenuates, resulting in an increase in a handover failure. Therefore, a need exists for methods and apparatuses for addressing such.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for reducing a handover failure in a wireless communication system using beamforming.

Another aspect of the present disclosure is to provide a method and apparatus for determining a handover situation by a terminal while a handover is performed in a wireless communication system to transmit a handover request message.

Another aspect of the present disclosure is to provide a method and apparatus for reducing a handover failure that may arise due to a failure to receive a handover command message transmitted from a target base station due to a signal attenuation of the serving cell while a handover is performed in a wireless communication system using beamforming.

In accordance with an aspect of the present disclosure, a method for a handover by a terminal in a communication system using beamforming is provided. The method includes receiving, from a serving base station, handover identification information related to at least one neighbor base station, measuring a reference signal of the serving base station and a reference signal of a target base station including the at least one neighbor base station, based on beam scanning, transmitting a handover request message comprising handover information to the serving base station if a result of the measuring meets a handover condition, receiving, from the target base station, a handover admittance message, and if a handover identifier obtained from the handover admittance message is a handover identifier of the target base station identified from the received handover identification information, performing an access procedure with the target base station.

In accordance with another aspect of the present disclosure, a method for supporting a handover of a terminal by a target base station in a communication system using beamforming is provided. The method includes transmitting, to a serving base station, a handover identifier of the target base station, transmitting a reference signal, receiving, form the serving base station, a handover request message, obtaining handover information from the handover request message, and transmitting, to the terminal, a handover admittance message comprising the handover identifier of the target base station based on the handover information.

In accordance with another aspect of the present disclosure, a terminal for a handover in a communication system using beamforming is provided. The terminal includes a transceiver configured to receive, from a serving base station, handover identification information related to at least one neighbor base station, and at least one processor configured to measure a reference signal of the serving base station and a reference signal of a target base station including one of the neighbor base station, based on beam scanning, if a result of the measuring meets a handover condition, control to the transceiver to transmit a handover request message comprising handover information to the serving base station, obtain a handover identifier from a handover admittance message received from the target base station, if the obtained handover identifier is a handover identifier of the target base station, identify the handover identifier of the target base station from the received handover identification information, perform access procedure with the target base station.

In accordance with another aspect of the present disclosure, a target base station for supporting a handover of a terminal in a communication system using beamforming is provided. The target base station includes a transceiver configured to transmit, to a serving base station, a handover identifier of the target base station, and transmit a reference signal, and if a handover request message is received from the serving base station, at least one processor configured to obtain handover information from the handover request message, and control the transceiver to transmit, to the terminal, a handover admittance message comprising the handover identifier of the target base station based on the handover information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a flowchart illustrating an example flow of handover operations including a beam selection process according to an embodiment of the present disclosure; 2

FIGS. 2A and 2B are views illustrating an example format of an identification (ID) for a handover according to an embodiment of the present disclosure;

FIGS. 3A, 3B, 3C and 3D are views illustrating an example of receive beam combinations of a terminal that the terminal may form corresponding to transmit beams of a serving base station and a target base station according to an embodiment of the present disclosure;

FIG. 4A is a view illustrating an example format of a handover admittance message in a case where a per-cell ID for a handover has a unique value according to an embodiment of the present disclosure

FIG. 4B is a view illustrating an example format of a handover admittance message in a case where a per-terminal ID for a handover has a unique value according to an embodiment of the present disclosure

FIG. 5 is a view illustrating another example of a handover process according to an embodiment of the present disclosure;

FIGS. 6A and 6B are views illustrating an example of a receive beam combination of a target base station that may be formed for a transmit beam of a terminal on uplink according to an embodiment of the present disclosure

FIG. 7 is a view illustrating another example of a handover process according to an embodiment of the present disclosure;

FIG. 8 is a view illustrating another example of a handover process according to an embodiment of the present disclosure;

FIG. 9A is a view illustrating an example format of a cell-specific HO-dedicated random-access channel (RACH) preamble according to an embodiment of the present disclosure;

FIG. 9B is a view illustrating an example format of a user-specific HO-dedicated RACH preamble according to an embodiment of the present disclosure;

FIG. 10 is a view illustrating an example of a handover condition detection interval according to an embodiment of the present disclosure;

FIG. 11A is a table illustrating examples of a beam pattern and beam change time as per the number of beams possessed by a terminal according to an embodiment of the present disclosure;

FIG. 11B is a flowchart illustrating an example of signal transmit/receive operations of a terminal having a broad beam pattern and a terminal having a narrow beam pattern according to an embodiment of the present disclosure

FIG. 12A is a flowchart illustrating an example of operations for adjusting a time to trigger (TTT) value corresponding to the number of beams of a terminal according to an embodiment of the present disclosure

FIG. 12B is a view illustrating an example of a TTT varying depending on beam patterns of a terminal according to an embodiment of the present disclosure

FIG. 13 is a view illustrating an example of the number of times in which a beam scanning is performed as per the number of beams of a terminal during a TTT according to an embodiment of the present disclosure;

FIG. 14 is a flowchart illustrating an example of handover operations including an operation for performing a measurement report as per a frequency band supported by a serving base station according to an embodiment of the present disclosure;

FIG. 15 is a flowchart illustrating an example of operations by a terminal according to the embodiment shown in FIG. 14;

FIG. 16 is a view illustrating an example configuration of a terminal according to an embodiment of the present disclosure; and

FIG. 17 is a view illustrating an example configuration of a base station according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms coming with ordinal numbers such as ‘first’ and ‘second’ may be used to denote various components, but the components are not limited by the terms. The terms are used only to distinguish one component from another. For example, a first component may be denoted a second component, and vice versa without departing from the scope of the present disclosure. The term “and/or” may denote a combination(s) of a plurality of related items as listed or any of the items. The terms as used herein are provided merely to describe some embodiments thereof, but not to limit the present disclosure. It is to be understood that the singular forms “a,” “an,” and “the” include plural references unless the context clearly dictates otherwise. It will be further understood that the terms “comprise” and/or “have,” when used in this specification, specify the presence of stated features, integers, operations, elements, and/or components, but do not preclude the presence or addition of one or more other features, integers, operations, operations, elements, components, and/or groups thereof. Unless otherwise defined in connection with embodiments of the present disclosure, all terms including technical and scientific terms used herein have the same meaning as commonly understood by one of ordinary skill in the art to which the embodiments of the present disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein. According to various embodiments of the present disclosure, the electronic device may include communication functionality. For example, the electronic device may be a smartphone, a tablet PC, a personal computer (PC), a mobile phone, a video phone, an e-book reader, a desktop PC, a laptop PC, a netbook PC, a personal digital assistant (PDA), a portable multimedia player (PMP), a Moving Picture Experts Group (MPEG-1 or MPEG-2) audio layer 3 (MP3) player, a mobile medical device, a camera, a wearable device (e.g., a head-mounted device (HMD)), electronic clothes, an electronic bracelet, an electronic necklace, an electronic appcessory, an electronic tattoo, or a smart watch. According to various embodiments of the present disclosure, the electronic device may be a smart home appliance having communication functionality. For example, the smart home appliance may be a television, a digital versatile disc (DVD) player, an audio player, a refrigerator, an air conditioner, a vacuum cleaner, an oven, a microwave oven, a washer, a drier, an air cleaner, a set-top box, a television (TV) box (e.g., Samsung HomeSync™, Apple TV™, or Google TV™), a gaming console, an electronic dictionary, a camcorder, or an electronic picture frame. According to various embodiments of the disclosure, the electronic device may be a medical device (e.g., magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, an sailing electronic device (e.g., a sailing navigation device, a gyroscope, or a compass), an aviation electronic device, a security device, or a robot for home or industry. It should be appreciated by one of ordinary skill in the art that the electronic device is not limited to the above-described devices. According to various embodiments of the present disclosure, the terminal may be, e.g., an electronic device. Methods and apparatuses as proposed according to embodiments of the present disclosure may apply to various communication systems, including institute of electrical and electronics engineers (IEEE) 802 communication systems, IEEE 802.16 communication systems, digital multimedia broadcasting (DMB) services, digital video broadcasting-handheld (DVP-H) and advanced television systems committee-mobile/handheld (ATSC-M/H) services or other mobile broadcasting services, internet protocol television (IPTV) services or other digital video broadcasting systems, moving picture experts group (MPEG) media transport (MMT) systems, evolved packet systems (EPSs), long-term evolution (LTE) mobile communication systems, LTE-advanced (LTE-A) mobile communication systems, high speed downlink packet access (HSDPA) mobile communication systems, high speed uplink (UL) packet access (HSUPA) mobile communication systems, 3rd generation project partnership 2 (3GPP2) high rate packet data (HRPD) mobile communication systems, 3GPP2 wideband code division multiple access (WCDMA) mobile communication systems, 3GPP2 code division multiple access (CDMA) mobile communication systems, mobile internet protocol (Mobile IP) systems, or so.

Hereinafter, according to the present disclosure, there are proposed methods and apparatuses for reducing a handover failure that arises due to a signal attenuation of a serving cell in a wireless communication system using beamforming.

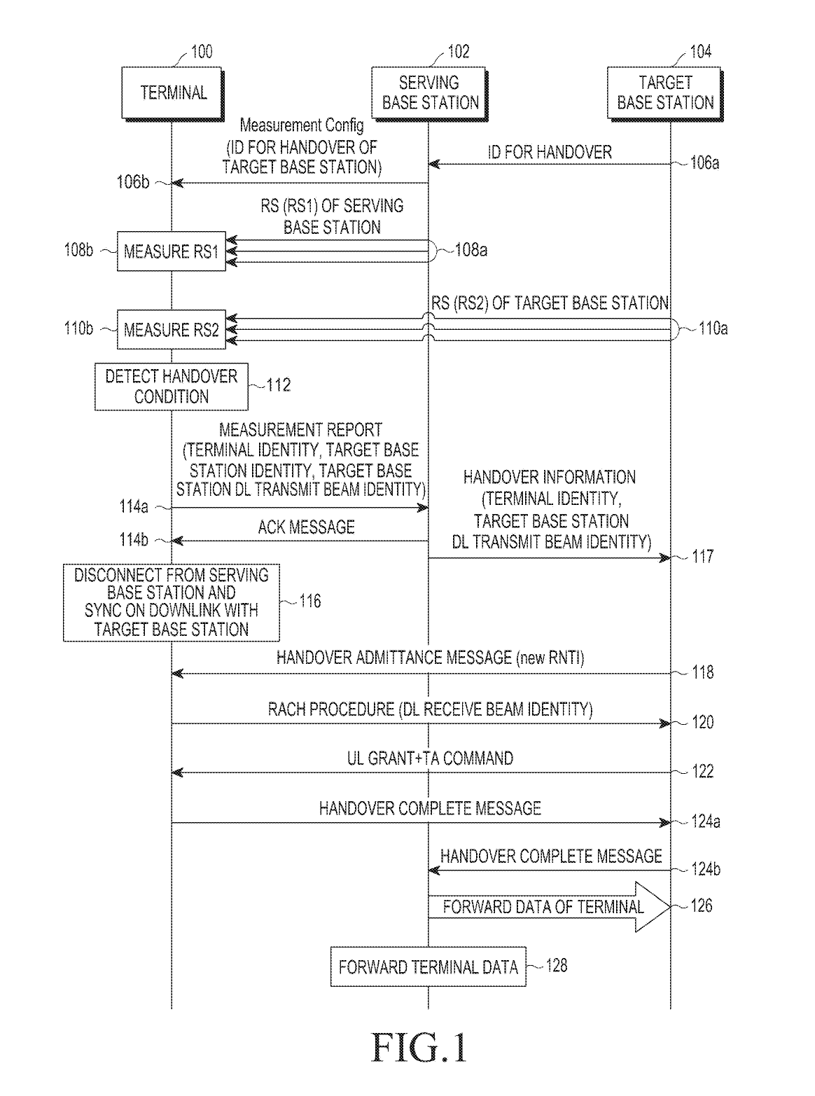

FIG. 1 is a flowchart illustrating an example flow of handover operations including a beam selection process according to an embodiment of the present disclosure.

Referring to FIG. 1, according to an embodiment of the present disclosure, a serving base station 102 notifies a terminal 100 of an ID for handover-radio network temporary identity (HO-RNTI) of a neighbor base station when the terminal 100 first accesses a network. Here, the identification (ID) for handover may also be used as information for the terminal to identify a handover-related message when base stations positioned around the serving base station 102 with which the terminal 100 is currently in connection send handover-related messages to terminals which are to attempt connection upon handover thereto. The ID for handover may be differentiated per base station or per terminal according to embodiments. It is assumed that each base station has IDs for handover of its neighbor base stations. According to an embodiment of the present disclosure, as the ID for handover, a fixed value may be used, or the handover ID may be varied by a base station. Further, the handover ID may be included in system information that is then broadcast from a base station to a terminal or may be included in a particular message (e.g., a Measurement Config) that may then be delivered to a corresponding terminal or it may be determined when a terminal is manufactured. In the embodiment shown in FIG. 1, a neighbor base station, e.g., a target base station 104, of the serving base station 102 delivers its handover ID to the serving base station 102, e.g., as in operation 106a. In operation 106b, the serving base station 102 then includes the handover ID in a particular message, a Measurement Config, and delivers to the terminal 100. According to an embodiment, the neighbor base station may include the handover ID in system information and broadcast the same to the terminal, notifying the terminal of the handover ID. In such case, the terminal may directly receive the handover ID from the neighbor base station, not from the serving base station. Further, according to an embodiment of the present disclosure, the terminal may receive a signal from another base station and the broadcast message using a measurement gap.

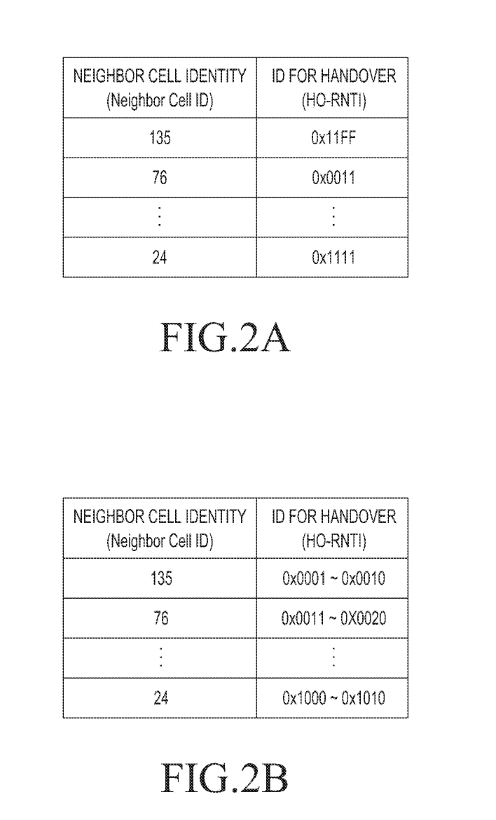

FIGS. 2A and 2B are views illustrating an example format of an ID for a handover according to an embodiment of the present disclosure.

The format of the handover ID may include multiple fields as follows. Here, the neighbor cell ID refers to an identity of a neighbor cell of the serving cell of a serving base station. According to an embodiment of the present disclosure, only one or multiple neighbor cell IDs may exist per cell.

As a specific example, the handover ID is information for identifying a handover admittance message when terminals located in the serving cell receive the handover admittance message from a cell (target cell) to which the terminals intend to hand over. That is, the terminal identifies the handover admittance message transmitted from the target base station 104 using the HO-RNTI value. According to an embodiment of the present disclosure, as the handover ID, one HO-RNTI may be used per neighbor base station, i.e., neighbor cell, identifier as disclosed in FIG. 2A. Or, as disclosed in FIG. 2B, multiple HO-RNTIs may be used per neighbor base station. In this case, the serving base station may assign one HO-RNTI per terminal.

In the embodiment of FIG. 1, the terminal 100 attached to the network receives a reference signal (RS) RS1 transmitted from the serving base station 102 in operation 108a and measures the strength of RS1 in operation 108b in order to monitor the radio link circumstance. Likewise, the terminal 100 receives a RS transmitted from the target base station 104—i.e., RS2—in operation 110a and measures the strength of RS2 in operation 110b. Generally, in a wireless communication system using beamforming, the strength of a RS is measured for all or some of transmit beam-receive beam combinations available in a radio link between a base station and a terminal. Here, the base station and the terminal measuring the signal while switching the transmit beams of the base station and the receive beams of the terminal is referred to as a beamscanning process. By such beam scanning process, the base station and the terminal may be aware of the quality of radio link for each of the transmit beams and the receive beams and may determine the optimal transmit beam and receive beam necessary for communication. According to an embodiment of the present disclosure, the beam scanning process may sequentially or simultaneously be carried out for either or both the serving base station to which the terminal is attached or/and the target base station to which the terminal is likely to hand over. Specifically, in the beam scanning process, a base station may transmit a RS through downlink (DL) and may transmit the RS while switching transmit beams used for the RS transmission sequentially or in a predetermined fashion or pattern. In this case, according to an embodiment of the present disclosure, the fashion or pattern in which the base station changes transmit beams may be previously known to the terminal, or the base station may notify the terminal of the manner or fashion. Or, the terminal may send a request for the beam switching fashion or pattern by sending, e.g., a beam change message to the base station. Likewise, when the base station transmits a RS, the terminal may also receive the RS and measure the strength of the RS while switching receive beams in a predetermined fashion or pattern. In this case, a beam presenting a good result of the measurement may be used upon communication with the base station, and information about the good beam may be reported to the base station. Or, according to an embodiment of the present disclosure, in order to simplify the beam scanning process, the terminal may receive a receive beam for each of a transmit beam from the serving base station and a transmit beam from the target base station in the form of an omni-beam. Also in a case where the terminal receives the RS, with the receive beam formed in an omni-beam when measuring the strength of the RS of the serving base station and target base station, the optimal transmit beam for the serving base station and the target base station may be determined.

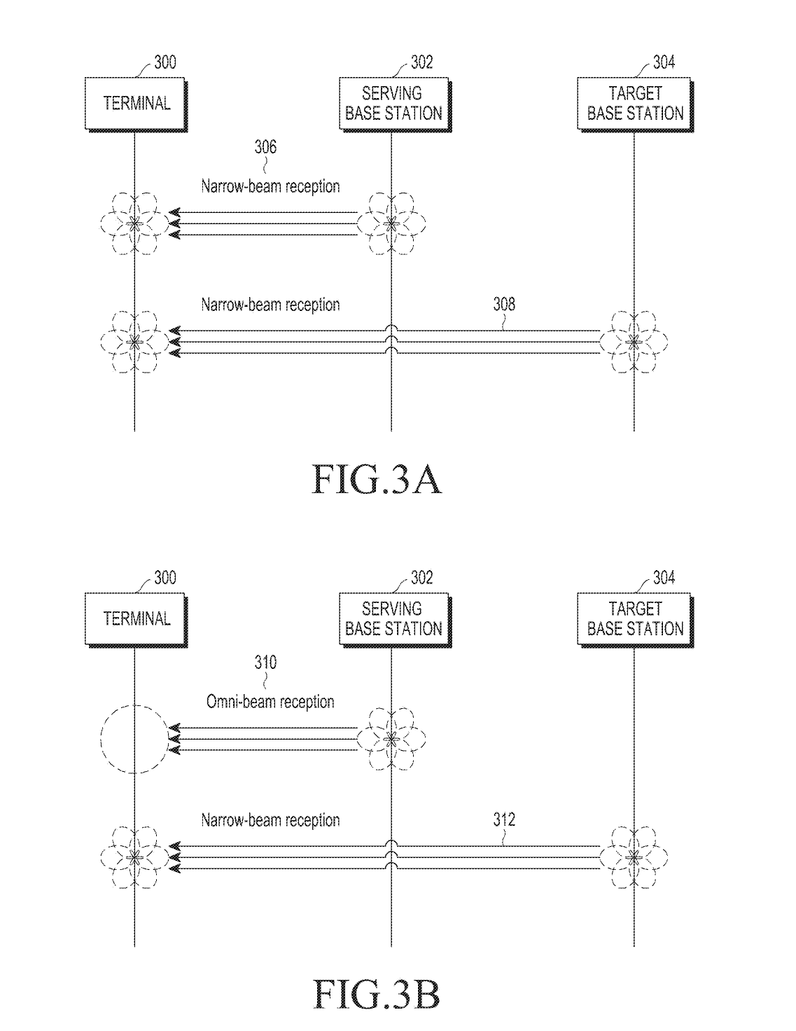

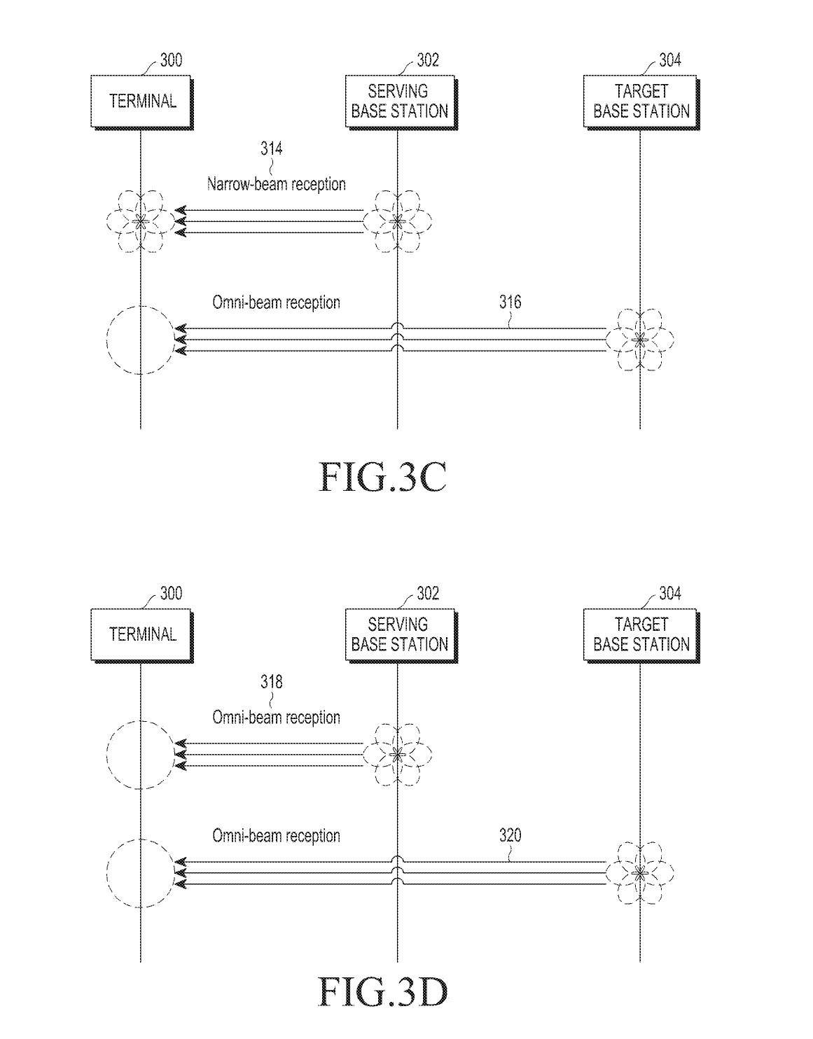

FIGS. 3A to 3D illustrate receive beam combinations of a terminal that the terminal may form corresponding to transmit beams of a serving base station and a target base station according to an embodiment of the present disclosure.

Referring to FIG. 3A, the terminal 300 receive a RS through receive beams corresponding to narrow beams for transmit beams of the serving base station 302 in operation 306. Likewise, the terminal 300 receive a RS through receive beams corresponding to narrow beams for transmit beams of the target base station 304 in operation 308. Referring to FIG. 3B, the terminal 300 receives a RS with an omni-beam corresponding to the transmit beams of the serving base station 302 in operation 310, and the terminal 300 receives a RS with receive beams corresponding to narrow beams for transmit beams of the target base station 304 in operation 312. Referring FIG. 3C, the terminal 300 receives a RS through receive beams corresponding to narrow beams for transmit beams of the serving base station 302 in operation 314. In operation 316, the terminal 300 receives a RS with an omni-beam corresponding to transmit beams of the target base station 304. FIG. 3D illustrates an example in which the terminal 300 receives a RS through receive beams corresponding to an omni-beam for the respective transmit beams of the serving base station 302 and the target base station 304 in operations 318 to 320.

It is assumed that the terminal 100 performs a beam scanning process based on a transmit/receive beam combination corresponding to one of the above-described embodiments, measures the RSs transmitted from the serving base station 102 or the target base station 104 or both the serving base station and the target base station in operation 112, and identifies that, as the result of the measurement, handover conditions are met (hereinafter, referred to as ‘handover condition detection’). Here, according to an embodiment of the present disclosure, the handover conditions are as follows.

Handover condition 1: where the RS of the serving base station, i.e., RS1, is larger than a particular threshold

As a specific example, such a setting may be made in which, where a RS, i.e., RS1, received from the serving base station has a larger strength than the sum of the threshold and a tolerance value (hysteresis), handover condition 1 begins, and where the strength of RS1 is smaller than the threshold minus the tolerance value, handover condition 1 ends. In this case, where neither the threshold nor the tolerance value reflects a beamforming gain, the terminal should deduct a beamforming gain from the strength of the RS received. Accordingly, in the instant embodiment, the serving base station notifies the terminal whether the threshold and the tolerance value contains a beamforming value upon transmission of a parameter for handover condition 1 to the terminal.

Handover condition 2: where the signal from the serving base station has a smaller strength than a particular threshold

Specifically, such a setting may be made in which, when the RS of the serving base station, i.e., RS1, is smaller than the threshold minus the tolerance value, handover condition 2 starts, and when the strength of RS1 is larger than the sum of the threshold and the tolerance value, handover condition 1 ends. Likewise, if neither the threshold nor the tolerance value reflects a beamforming gain, the terminal should deduct a beamforming gain from RS1. Accordingly, in the instant embodiment, the serving base station notifies the terminal whether the threshold and the tolerance value contains a beamforming value upon transmission of a parameter for handover condition 2 to the terminal.

Handover condition 3: where the RS of a neighbor base station, i.e., RS2, is larger than a particular threshold

Specifically, such a setting may be made in which, when RS2 is larger than the sum of RS1 of the serving base station, an offset, and a tolerance value, handover condition 3 starts, and when the signal of the neighbor base station is smaller than the sum of RS1 and the offset minus the tolerance value, handover condition 3 ends. Also in this case, if neither the offset nor the tolerance value reflects a beamforming gain, the terminal should deduct a beamforming gain from RS1 and RS2. Accordingly, in the instant embodiment, the serving base station notifies the terminal whether the offset and the tolerance value contains a beamforming value upon transmission of a parameter for handover condition 3 to the terminal. Further, when receiving RS1 and RS2, the terminal needs to compare signal strengths as per whether there is reception beamforming, with a beamforming gain subtracted. For example, although the terminal does not perform beamforming because it uses an omni-beam upon reception of RS1 from the serving base station in the case shown in FIG. 3B, 310, beamforming is based when the terminal receives RS2 from the target base station 312. In this case, upon using handover condition 3, the terminal should make comparison with the receive beamforming gain of the terminal removed from RS2 of the target base station. Further, in the case shown in FIG. 3C, the terminal receives RS1 of the serving base station based on beamforming in operation 314 and receives RS2 of the target base station using an omni-beam without beamforming in operation 316. Thus, when handover condition 3 is used in the case shown in FIG. 3C, the receive beamforming gain of the terminal should be removed from RS1 upon comparison. This can be represented in the following equation.

Handover condition 4: where RS2 of a neighbor base station is larger/different from a particular threshold

Specifically, such a setting may be made in which, where RS2 is larger than the sum of the threshold and the tolerance value minus the offset, handover condition 4 starts, and where RS2 is smaller than the threshold minus the tolerance value and offset, handover condition 4 terminates. Likewise, under handover condition 4, if none of the threshold, tolerance value, and offset reflect a beamforming gain, the terminal should deduct a beamforming gain from RS2. Accordingly, in the instant embodiment, the serving base station notifies the terminal whether the threshold, the tolerance value, and offset contain a beamforming value upon transmission of a parameter for handover condition 4 to the terminal.

Handover condition 5: where RS1 of the serving base station is smaller than a first threshold, and RS2 is larger than a second threshold

Specifically, such a setting may be made in which when RS1 is smaller than the first threshold (Threshold1) minus a tolerance value, and RS2 is larger than the sum of the second threshold (Threshold2) and the tolerance value, minus an offset, handover condition 5 starts, and when RS1 is larger than the sum of Threshold1 and the tolerance value, and RS2 is smaller than Threshold2 minus the sum of the tolerance value and the offset, handover condition 5 ends. Also under handover condition 5, if neither the thresholds nor the tolerance value reflects a beamforming gain, the terminal should deduct a beamforming gain from RS1 and RS2. Accordingly, according to an embodiment of the present disclosure, the serving base station notifies the terminal whether the thresholds and the tolerance value contain a beamforming value upon transmission of a parameter for handover condition 5 to the terminal. Further, when receiving RS1 and RS2, the terminal needs to compare signal strengths as per whether there is reception beamforming, with a beamforming gain subtracted. This condition is the same as handover condition 3, and no repetitive description thereof is given.

Then, the terminal includes a measurement result obtained through the beam scanning process to perform a handover and sends the same to the serving base station 102 in operation 114a. Here, the measurement report message may include at least one or more of a mobile station (MS) ID, a Target base station (BS) ID, and a Target BS downlink (DL) TX Beam ID. Specifically, the MS ID means the identity of a terminal to perform a handover—i.e., the terminal 100. The Target BS ID means the ID of a base station, i.e., the target base station 104, to which to be attached through a handover. The Target BS DL TX beam ID is used to indicate a downlink transmit beam to be used when a corresponding neighbor base station transmits data to the terminal or upon starting to perform a handover process with the terminal. In other words, the Target BS DL TX Beam ID denotes the ID of an optimal transmit beam of the target base station, obtained by the terminal through the beam scanning process on the base station. According to an embodiment of the present disclosure, the Target BS DL TX Beam ID may be determined to be a transmit beam of the target base station that has sent a RS having a maximum signal strength while the terminal receives RSs. If the terminal receives the RS in the form of beamforming, not in the form of an omni-beam, for the receive beam, the terminal may have had the ID information regarding the optimal receive beam appropriate for use in communication with the target base station also for the receive beams as it does on the transmit beams of the base station. In this case, the ID information about the receive beam may be defined as a Target BS DL RX Beam ID.

Thereafter, if correctly receiving the measurement report transmitted from the terminal 100 in operation 114a, the serving base station 102 sends an ACK message to the terminal 100 in operation 114b. Here, according to embodiments, the ACK message may be a radio resource control (RRC) layer message, an ACK in an automatic repeat request (ARQ) process operated on the media access control (MAC) or radio link control (RLC) layer, or an ACK in a hybrid ARQ (HARQ) process. Hence, in an embodiment of the present disclosure, the ACK message may contain a handover indicator to identify that the ACK message is an ACK for handover. According to an embodiment of the present disclosure, the terminal 100 may send a measurement report message regardless of whether an ACK is received or not and may then perform a handover to the target base station 104.

Upon reception of the ACK message, the terminal 100 disconnects from the serving base station 102 and immediately performs a procedure to sync with the target base station 104 for downlink in operation 116. After the downlink sync, the terminal 100 waits to receive a handover admittance message that is to be transmitted from the target base station 104.

According to an embodiment of the present disclosure, upon reception of the measurement report from the terminal 100, the serving base station 102 transmits handover information of the terminal 100 to the target base station 104 where the terminal 100 is supposed to do a handover in operation 117. Here, the handover information may include at least one of the MS ID and the BS DL TX Beam ID. In the embodiment shown in FIG. 1, the serving base station 102, after sending an ACK message to the terminal 100, transmits the handover information to the target base station 104. The ACK message may contain the ID of a random-access channel (RACH) preamble that is to be used in a random-access process with the target base station 104 after the handover. As another example, the RACH preamble ID may have already been included in a measurement configuration (Measurement Config) message. As still another example, the handover admittance message may contain the RACH preamble ID.

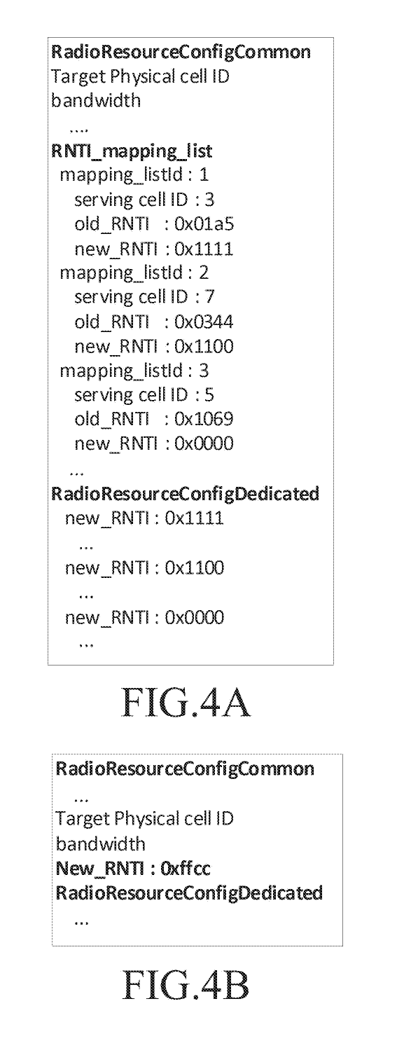

The target base station 104, after receiving the handover information from the serving base station, transmits the handover admittance message containing the HO-RNTI of the target base station 104 to the terminal 100 in operation 118. Here, the handover admittance message may be transmitted through a control channel, e.g., a LTE physical downlink control channel (PDCCH). According to an embodiment of the present disclosure, the target base station 104 may also transmit the handover admittance message using a transmit beam corresponding to the Target BS DL TX Beam ID obtained from the handover information. The handover admittance message happens to have different formats depending on usages of the HO-RNTI. As shown in FIG. 2A, when the HO-RNTI has a cell-specific value per neighbor cell, it may be represented in a format as shown in FIG. 4A.

FIG. 4A is a view illustrating an example format of a handover allow message in a case where a per-cell ID for a handover has a unique value according to an embodiment of the present disclosure.

Referring to FIG. 4A, according to an embodiment of the present disclosure, the handover admittance message may include common information (RadioResourceConfigCommon) of the target base station, a terminal identity mapping list (RNTI_mapping_list), and user-dedicated information (RadioResourceConfigDedicated). Here, the common information refers to system information for transmitting and receiving at the target base station. The terminal identity mapping list is a list for allocating a terminal identity (RNTI) to be used by the target base station for terminals. Since a terminal identifies the handover admittance message through the HO-RNTI, there is no identity (RNTI) allocated to the terminal 100 to identify the target base station until it receives the handover admittance message. Therefore, in the instant embodiment, as in the embodiment shown in FIG. 4A, a terminal identity (new_RNTI) to be used by the target base station may be allocated based on the terminal identity (old_RNTI) that has been used by the serving base station and the serving base station ID (serving_cell_ID). Thereafter, the user-dedicated information provides the terminal identity (new_RNTI) that is to be used by the target base station.

Meanwhile, as shown in FIG. 2B, when the HO-RNTI has a (user-specific) particular value per terminal, it may be represented in a format as shown in FIG. 4B.

FIG. 4B is a view illustrating an example format of a handover allow message in a case where a per-terminal ID for a handover has a unique value according to an embodiment of the present disclosure. Here, the handover admittance message may contain common information (cell common information) of the target base station and user-dedicated information (user dedicate information).

Referring to FIG. 4B, according to an embodiment of the present disclosure, the handover admittance message has common information (RadioResourceConfigCommon) of the target base station, a terminal identity (new_RNTI), and user-dedicated information (RadioResourceConfigDedicated). Here, the common information refers to system information for transmitting and receiving at the target base station. The terminal identity (new_RNTI) is a terminal identity to be used by the target base station for the terminal. Since, in the embodiment shown in FIG. 4B, the handover admittance message is identified through the HO-RNTI, the handover admittance message is a message that is received by only one terminal. Thus, a new terminal identity for one terminal may be allocated. Thereafter, as the user-dedicated information, various user-dedicated information may be included that is necessary to attempt access to the target base station, such as a handover-dedicated access code.

Referring to FIG. 1, in operation 118, after the target base station 104 sends the handover admittance message, the target base station 104, the terminal 100 receiving the same, or both the target base station 104 and the terminal 100 may operate the handover timer (HO Timer). At this time, the expiration time of the handover timer may be previously defined or may be transmitted in the handover admittance message. According to an embodiment of the present disclosure, the handover time stops if the terminal completes the handover procedure with the target base station, and if the handover timer expires before then, the handover to the target base station is deemed to have failed. The completion of the handover procedure may be defined by, e.g., the transmission of a handover complete message.

Accordingly, according to an embodiment of the present disclosure, the terminal 100, after receiving the handover admittance message, may perform a random-access process (RACH Procedure) in operation 120. Here, the random-access process begins as the terminal 100 transmits a random-access code (RACH Code) to the target base station 104. At this time, upon transmitting the random-access code, the terminal 100 may use, as a transmit beam for transmitting the random-access code (RACH Code), the beam corresponding to the receive beam ID (DL Target BS RX Beam ID) that it has previously used upon receiving the RS from the target base station, according to an embodiment of the present disclosure. If the RACH process fails despite transmission of the random-access code using the DL Target BS RX Beam ID, the terminal 100 may reattempt the transmission of the random-access code using all transmit beams that may transmit the random-access code. Here, the random-access process may include at least one of the process of transmitting the random-access code, the process of transmitting the random-access response message by t8he base station, the process of transmitting timing advance (TA) information to the terminal, and the process of allocating an uplink resource (UL Grant) for data transmission. In the embodiment shown in FIG. 1, shown is a process in which the target base station 104 transmits a UL grant and TA to the terminal 100 in operation 122, as an example.

After the random-access process is complete, the terminal 100 sends a handover complete message to the target base station 104 in operation 124a, completing the handover. Then, the target base station 104, after completely receiving the handover complete message from the terminal 100, sends the handover complete message to the serving base station 102 in operation 124b. At this time, the handover complete message sent from the target base station 104 to the serving base station 102 may have the same or different content from that transmitted from the terminal 100 to the target base station 104, according to an embodiment of the present disclosure. If the serving base station 102 receives the handover complete message, the serving base station 102 forwards the data of the terminal 100, which the serving base station 102 possesses, to the target base station 104 in operation 126, and the serving base station 102 terminates the connection with the terminal 100 in operation 128. Although not shown in the drawings, the target base station 104 then operates as a new serving base station of the terminal 100.

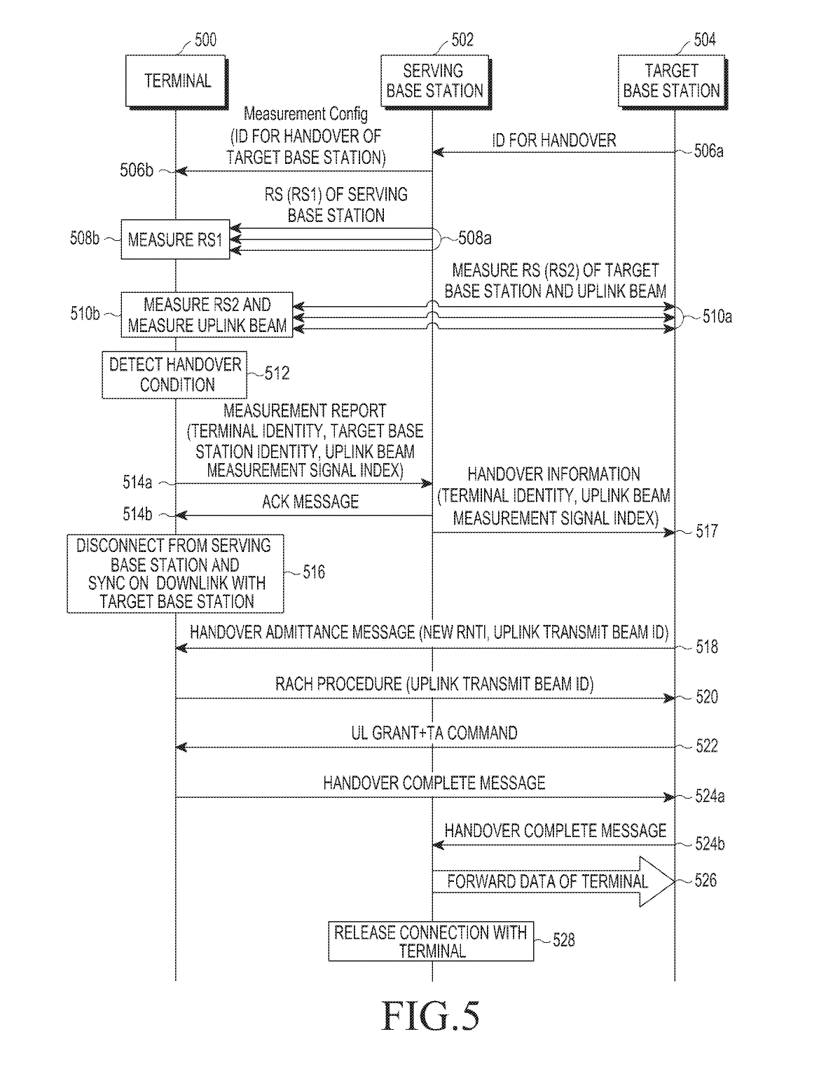

FIG. 5 is a view illustrating another example of a handover process according to an embodiment of the present disclosure.

Referring to FIG. 5, when the terminal 500 first accesses the network, the serving base station 502 provides a handover ID (HO-RNTI) of a neighbor base station, e.g., the target base station 504 in operation 506b. Here, the handover ID is used as information for the terminal to identify a handover-related message when target base stations positioned around the serving base station with which the terminal is currently in connection send handover-related messages to terminals which are to attempt connection upon handover thereto. Such handover ID may be distinct per base station or per terminal. All the base stations have handover IDs of neighbor base stations. As the ID for handover, a fixed value may be used, or the handover ID may be varied by a base station. The handover ID may be broadcast by a corresponding base station through system information, may be transmitted to a corresponding terminal in a particular message, or may be determined upon manufacturing terminal. In the embodiment shown in FIG. 5, a case is shown in which the target base station 504 previously sends its own handover ID to the serving base station 502 as in operation 506a, and the serving base station 502 transfers the handover ID to the terminal 500 through a particular message, e.g., a Measurement Config. According to an embodiment of the present disclosure, the target base station 504 may directly deliver its handover ID to the terminal 500 by including the handover ID in system information and broadcasting the same. Further, according to an embodiment of the present disclosure, the terminal 500 may receive signals or messages broadcast from other base stations using a measurement gap. The same definition as made for the HO-RNTI in the above description applies, and no further detailed description thereof is given.

The terminal 500 accessing the network measures a RS (RS1) transmitted from the base station to monitor the radio link circumstance. Specifically, in the case of the embodiment shown in FIG. 5, the serving base station 502 sends a RS, i.e., RS1, through downlink in operation 508a. At this time, the serving base station 502 may transmit RS1 while switching transmission beams used in transmitting RS1. In this case, the fashion or pattern in which the beams are changed may be previously known to the terminal, or the base station may notify the terminal of the manner or fashion. Or, the terminal may send a request for the beam switching fashion or pattern to the base station through, e.g., a beam change message. Meanwhile, upon reception of RS1 from the serving base station 502, the terminal may measure RS1 while switching its receive beams. At this time, it may use a beam giving a good measurement result in communication and may report information about the good beam to the serving base station 502. Or, according to an embodiment of the present disclosure, in order to simplify the beam scanning process, the terminal may receive a receive beam for each of a transmit beam from the serving base station and a transmit beam from the target base station in the form of an omni-beam. Also in a case where the terminal receives the RS, with the receive beam formed in an omni-beam, the optimal transmit beam for the serving base station and the target base station may be determined. The same description as has been made in connection with FIGS. 3A to 3D applies to the operation of the terminal to form the receive beam for the serving base station and the target base station, and no repetitive description thereof is presented.

Further, in the embodiment shown in FIG. 5, the terminal 500 measures transmit beams of the target base station 504, i.e., a RS signal (RS2) received through downlink, in operation 510b. The terminal 500, the serving base station 502 and the target base station 504 perform a beam scanning process, measurement procedure, also on an uplink signal through beam combinations also for uplink (UL). Here, the downlink measurement process is performed in the same manner as the measurement process of FIG. 1. In contrast, for the uplink measurement process, an uplink beam measurement signal may be used to perform measurement on the transmit beam of the terminal and the receive beam of the base station for uplink, measurement may be performed using a random-access code for measuring an uplink beam, or other methods for measuring uplink may come into use, according to embodiments. Further, according to an embodiment of the present disclosure, one uplink beam measurement signal or one random-access code for uplink beam measurement may be used per base station. Or, as multiple uplink beam measurement signals or random-access codes for uplink beam measurement may be allocated per base station, the serving base station may allocate one random-access code for uplink beam measurement per terminal or multiple uplink beam measurement signals for the corresponding base station. According to an embodiment of the present disclosure, the uplink beam measurement signal or random-access code for uplink beam measurement may also be provided by the base station to the terminal through a broadcast message, may be provided to the terminal in a particular message, e.g., a Measurement Config, or may be determined upon manufacturing the terminal. According to an embodiment of the present disclosure, the base station should previously inform neighbor base stations of its uplink beam measurement signal or random-access code for uplink beam measurement through the backhaul. Accordingly, the neighbor base stations may interpret the same as meaningful information upon reception of the uplink beam measurement signal or random-access code for uplink beam measurement transmitted from the terminals.

According to an embodiment of the present disclosure, in the process of measuring uplink, the beam measurement signal or random-access code of random-access channel contains the ID of the optimal transmit beam of the base station obtained by the terminal through the measurement process. As an example, the optimal transmit beam is determined as the transmit beam of the base station having transmitted the RS having the maximum signal strength among the RSs received by the terminal among the transmit beams of the base station on downlink. Further, according to an embodiment of the present disclosure, the beam measurement signal or the random-access code of random-access channel also contains the terminal's uplink transmit beam ID for identifying the uplink transmit beam. Accordingly, according to an embodiment of the present disclosure, if the uplink beam measurement process is performed, the base station may be aware of the optimal transmit beam for downlink for the terminal contained in the beam measurement signal, and the base station may know the optimal transmit beam and receive beam for uplink by measuring the beam measurement signal.

Further, according to an embodiment of the present disclosure, in order to reduce the uplink beam scanning process, the receive beam of the target base station for uplink may also be received in the form of an omni-beam. In this case, the target basement station may determine the optimal uplink transmit beam of the terminal even when receiving the RS from the terminal by constituting the receive beam in the omni-beam form upon measuring the uplink beam measurement signal or random-access code signal for uplink beam measurement.

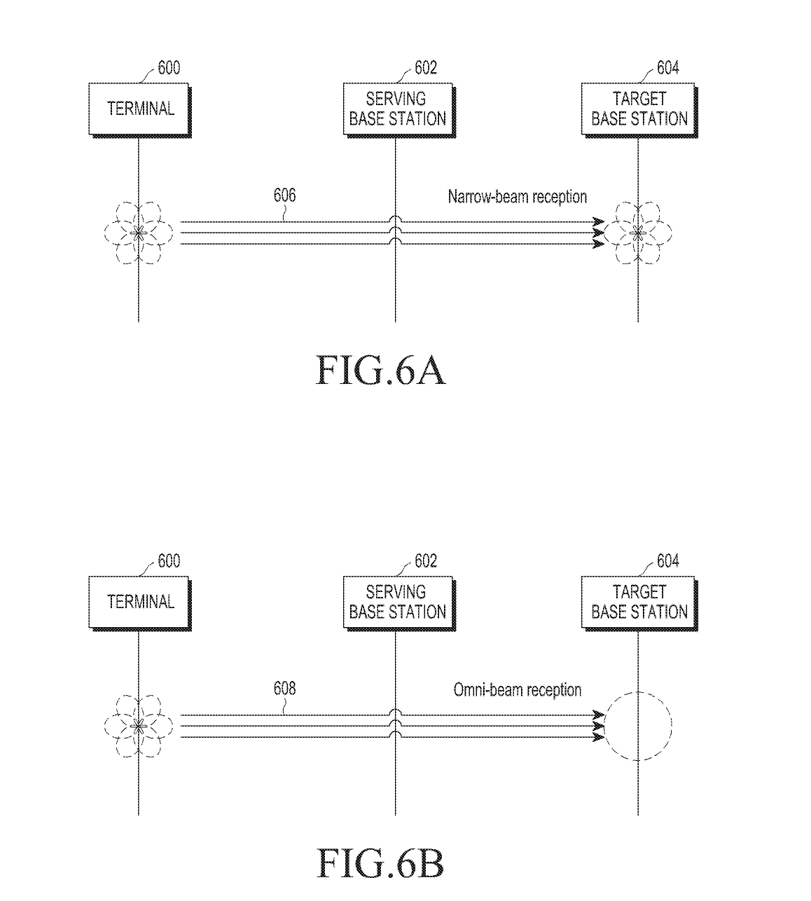

FIGS. 6A and 6B are views illustrating an example of a receive beam combination of a target base station that may be formed for a transmit beam of a terminal on uplink according to an embodiment of the present disclosure. FIG. 6A illustrates a case where, in operation 606, the target base station 604 receives an uplink signal from the terminal 600 by forming receive beams corresponding to a plurality of narrow beams for the uplink signal. FIG. 6B illustrates a case where, in operation 608, the target base station 604 receives an uplink signal from the terminal 600 by forming an omni-beam for the uplink signal. The serving base station 602 may relay the uplink signal from the terminal 600 to the target base station 604, as illustrated in FIGS. 6A and 6B.

Further, according to an embodiment of the present disclosure, there is proposed a method for managing a target base station group that is to perform a beam scanning process in order to simplify the uplink beam scanning process. The terminal uses a plurality of beams upon performing an uplink beam scanning process with target base stations where a handover is to be performed, which may result in the terminal significantly consuming power. Hence, as the number of target base stations increases, the terminal may be subject to an overhead in the uplink beam scanning process. Therefore, according to an embodiment of the present disclosure, there is proposed a scheme in which the terminal selects a target base station with which the terminal is to perform beam scanning. Specifically, according to an embodiment of the present disclosure, a target base station group which will perform an uplink beam scanning process may be chosen as follows. The terminal receives RSs from target base stations in a downlink beam scanning process. The terminal puts the target base station that has sent a RS whose strength is higher than a particular threshold (Threshold_uplink_group), as a result of receiving the RSs from the target base stations, in the target base station group for performing an uplink beam scanning process.

Resultantly, according to an embodiment of the present disclosure, the terminal performs an uplink beam scanning process only on at least one target base station included in the target base station group for performing the uplink beam scanning process, chosen as above, rather than performing the uplink beam scanning process on all the target base stations. According to an embodiment of the present disclosure, as another condition for determining the target base station group that is to perform an uplink beam scanning process, among the target base stations, only the ones having sent downlink receive signals received by the terminal and whose strength is the maximum value may be included in the target base station group for performing the uplink beam scanning process.

In another embodiment of the present disclosure, information about the target base station group to perform the uplink beam scanning process may be broadcast by the serving base station to the terminal as system information. In this case, the serving base station may inform of the group of target base stations to which a handover may be performed from the current location of the terminal based on the terminal's location. Then, the terminal performs the uplink beam scanning process only on at least one target base station included in the target base station group informed of by the serving base station. In another embodiment, the serving base station may provide information about the group of target base stations to which a handover may be made depending on the terminal's current speed.

In still another embodiment of the present disclosure, the serving base station may inform of the group of target base stations to which a handover may be made depending on the time period during which the terminal currently stays in the service coverage of the serving base station. In another embodiment, the serving base station may inform of the group of target base stations to which a handover may be made depending on the distance between the serving base station and the terminal. According to an embodiment of the present disclosure, if all the base stations transmit their respective traffic loads in cell to neighbor base stations, all the base stations may inform the terminals located in their cells of the group of target base stations to which the terminal may hand over based on the traffic loads. In this case, base stations whose traffic load is higher than a predetermined threshold among the neighbor base stations are excluded from the target base station group. The base station may inform the terminal of the group of target base stations to perform an uplink beam scanning process also through other methods than those in the above-described embodiments.

In the embodiment shown in FIG. 5, it is assumed that the terminal 500 performs a beam scanning process upon measuring RS1 and RS2 in operations 508b to 510b and detects a handover condition in operation 512. In this case, in operation 514a, the terminal includes a measurement result in a measurement report message to perform a handover and transmits the same to the serving base station 502. Here, the handover condition corresponds to one of the handover conditions described above in connection with FIG. 1, and no repetitive description thereof is provided. The measurement report message may contain at least one of a MS ID, a Target BS ID, and a UL beam measurement signal index. Here, the MS ID means the ID of a terminal to perform a handover, i.e., the terminal 500, and the Target BS ID denotes the ID of a base station to which access is to be made through the handover, i.e., the target base station 504. The UL beam measurement signal index denotes the index of a transmit signal used by the terminal for uplink beam measurement. As an example of the UL beam measurement signal index, it may be used as a value for informing of the ID of the optimal uplink transmit beam when the target base station 504 sends a handover admittance message in operation 518. That is, assuming that the transmit beam measurement signal or random-access code for uplink transmit beam measurement used upon uplink beam measurement is allocated per terminal, the terminal may be informed of the ID of the optimal uplink transmit beam through the UL beam measurement signal index. In other words, since the terminal 500, although having performed the uplink beam scanning process to the target base station 504, has not yet received the ID of the optimal uplink transmit beam from the target base station 504, it may be unaware of the optimal uplink transmit beam. Accordingly, the terminal should receive information about the optimal uplink transmit beam through the handover admittance message, and to that end, informs of the index of the transmit signal that the terminal has used in the uplink beam scanning process. The target base station 504, if the uplink beam scanning process is performed from multiple terminals, may be aware of the uplink transmit beam ID of each terminal. However, since the transmit signal lacks terminal information, it is unaware what the terminal is. Accordingly, the target base station 504 identify the terminal 500 through the uplink beam measurement signal index (UL beam measurement signal index) and the terminal identity contained in the handover information received from the serving base station 502 in operation 517, then target base station 504 transmit to the identified terminal 500 the ID of the optimal uplink transmit beam is known.

Thereafter, the serving base station 502, if having exactly received the measurement report, sends an ACK message to the terminal 500 in operation 514b. At this time, the ACK message may be a RRC layer message, an ACK in an ARQ process operated on the MAC or RLC layer, or an ACK in an HARQ process. In this case, the ACK message may contain a handover indicator to differentiate whether the ACK message is one for a handover. According to an embodiment of the present disclosure, the terminal 500 may send a measurement report message regardless of whether an ACK is received or not and may then perform a handover to the target base station.

In the embodiment shown in FIG. 5, upon reception of the ACK message, the terminal 500 disconnects from the serving base station 502 and immediately performs a procedure to sync with the target base station 504 for downlink in operation 516. After the downlink sync, the terminal 500 waits to receive a handover admittance message.

According to an embodiment of the present disclosure, the serving base station 502, after receiving the measurement report, may send handover information of the terminal 500 to the target base station 504 to which the terminal 500 is to perform a handover in operation 517. Here, the handover information may contain at least one of a MS ID and an UL beam measurement signal index. The UL beam measurement signal index may be used for the target base station 504 to inform of the ID of the optimal uplink transmit beam of the terminal through the handover admittance message. This is why the target base station 504 already knows the optimal uplink transmit beam of the terminal having sent the UL beam measurement signal through a downlink/uplink beam scanning process before handover through the received UL beam measurement signal index. Accordingly, the terminal may be aware of the ID of the optimal transmit beam to the target base station 504 if it receives the handover admittance message.

The embodiment of FIG. 5 shows a case where, after the serving base station 502 sends an ACK message containing a handover indicator to the terminal 500, it sends the handover information to the target base station 504 in operation 517. In this case, the ACK message may contain the ID of a RACH preamble to be used in a random-access process with the target base station 504 after handover. According to another embodiment, the RACH preamble ID may have been included and transmitted in a measurement configuration (Measurement Config) message as in operation 506b. According to another embodiment, the handover admittance message may contain a RACH preamble ID.

The target base station 504, after receiving the handover information from the serving base station 502, transmits the handover admittance message containing the HO-RNTI of the target base station to the terminal 500 in operation 518. The handover admittance message contains the terminal identity (new_RNTI) to be used when communicating later with the target base station. The terminal identity is allocated in the same manner as that described in connection with FIG. 1, and thus, no repetitive description thereof is given. Here, the handover admittance message may be transmitted through a control channel, such as the LTE PDCCH. According to an embodiment of the present disclosure, the target base station 504 may include the Target BS DL TX Beam ID of the one having sent the UL beam measurement signal in the handover admittance message and transmit the same. Here, the handover admittance message happens to have different formats depending on usages of the HO-RNTI. According to the HO-RNTI format shown in FIGS. 2A and 2B as described above, the handover admittance message may be configured by the method shown in FIGS. 4A and 4B. Since the description of the method for configuring the handover admittance message is the same as that described above, it is not repetitively described any longer.

In the embodiment of FIG. 5, the handover admittance message may add the following besides those described in connection with the embodiment of FIG. 1. It may contain at least one of uplink transmit beam information (UL TX Beam ID) to be used by the terminal for a random-access process (RACH Procedure) and uplink receive beam information (UL RX Beam ID) of the base station.

After sending the handover admittance message, the target base station 504, the terminal 500, or both the target base station 504 and the terminal 500 may operate the handover timer. The expiration time of the handover timer may be previously defined or may be included in the handover admittance message in operation 518. Here, the handover timer, when the terminal 500 completes the handover procedure with the target base station 504, stops, and if the handover timer expires before then, it is deemed a failure of the handover. The completion of the handover procedure may be defined by, e.g., the transmission of a handover complete message.

In the embodiment of FIG. 5, after receiving the handover admittance message, the terminal 500 may perform a random-access process in operation 520. The random-access process begins as the terminal 500 transmits a random-access code to the target base station 504. At this time, the terminal 500 may transmit the random-access code using the beam of the uplink transmit beam ID (UE UL TX Beam ID) received through the handover admittance message. Upon failure of the RACH process despite having sent the random-access code using the beam of the uplink transmit beam ID (UE UL TX Beam ID), the terminal 500 may send the random-access code through all transmittable transmit beams. The random-access process may include at least one of the process of transmitting the random-access code, the process of transmitting the random-access response message by the base station, the process of transmitting TA information to the terminal, and the process of allocating a UL Grant for data transmission. In the embodiment of FIG. 5, the random-access process denotes the case where the target base station 504 transmits the UL grant and TA command to the terminal 500 in operation 522. After completing the random-access process, the terminal 500 sends a handover complete message to the target base station 504 in operation 524a, completing the handover. Then, the target base station 504, after completely receiving the handover complete message from the terminal 500, sends the handover complete message to the serving base station 502 in operation 524b. The handover complete message sent from the target base station 504 to the serving base station 502 may have the same or different in content from the handover complete message transmitted from the terminal to the target base station, according to an embodiment of the present disclosure. If the serving base station 502 receives the handover complete message, the serving base station 502 forwards the data of the terminal 500, which the serving base station 502 possesses, to the target base station in operation 526, and the serving base station 502 terminates the connection with the terminal 500 in operation 528. Thereafter, the target base station 504 likewise operates as a new serving base station of the terminal 500.

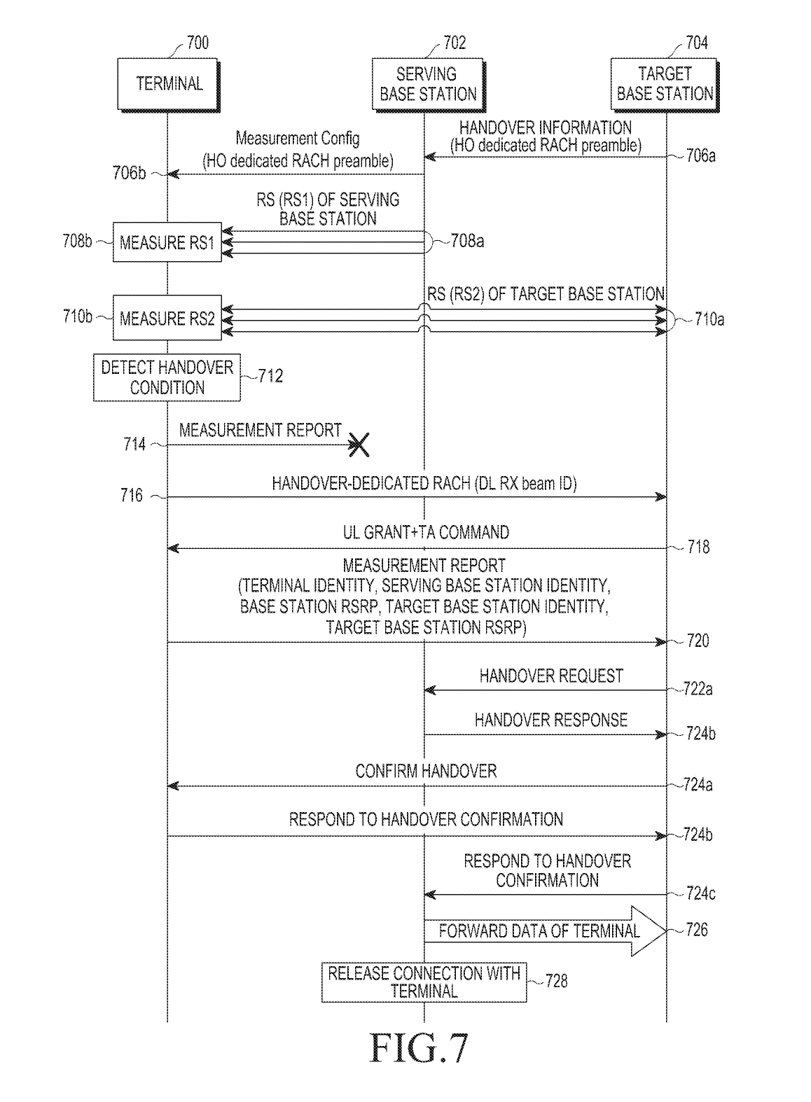

FIG. 7 is a view illustrating another example of a handover process according to an embodiment of the present disclosure.

Referring to FIG. 7, when the terminal 700 first accesses the network, the serving base station 702 includes a RACH Preamble (HO-Dedicated RACH Preamble) for a handover to the target base station 704 in a Measurement Config and sends the same to the terminal 700. Here, the handover RACH Preamble may be distinct per base station or per terminal according to an embodiment of the present disclosure. Each of all the base stations has a RACH Preamble for handover of a neighbor base station. The handover RACH Preamble may be a fixed value or may be varied by the base station according to an embodiment of the present disclosure. Further, according to an embodiment of the present disclosure, the handover RACH Preamble may be broadcast to the terminal by a corresponding base station through system information, or as in operation 706b, may be transmitted to a corresponding terminal in a particular message (Measurement Config), or may be determined upon manufacturing terminal. In the embodiment of FIG. 7, a case is shown in which, as an example of a neighbor base station, the target base station 704 has previously transferred the handover RACH Preamble to the serving base station 702 in operation 706a. According to an embodiment of the present disclosure, the neighbor base station may allocate only one handover RACH Preamble to the serving base station, or if allocating multiple handover RACH Preambles, the serving base station may allocate the handover RACH Preambles to multiple terminals one by one. Further, according to an embodiment of the present disclosure, the handover RACH Preamble may be broadcast to a corresponding terminal through system information directly by the neighbor base station. In such case, the terminal may directly receive the handover RACH Preamble from the neighbor base station, not from the serving base station. The terminal may receive signals and broadcast messages from other base stations using a measurement gap.

In the embodiment of FIG. 7, the terminal 700 accessing the network measures a RS transmitted from the base station to monitor the radio link circumstance. Specifically, the serving base station 702 sends a RS, i.e., RS1, through downlink in operation 708a. At this time, the serving base station 702 may transmit RS1 while switching beams used in transmitting RS1. In this case, it is assumed that the fashion or pattern in which the beams are changed has been known to the terminal or base station by one of the above-described methods. Meanwhile, upon reception of RS1 from the serving base station 702, the terminal 700 may measure RS1 while switching its receive beams. At this time, it may use a beam giving a good measurement result in communication and may report information about the good beam to the serving base station 702. Or, in order to simplify the beam scanning process, the terminal may receive a receive beam for each of a transmit beam from the serving base station and a transmit beam from the target base station in the form of an omni-beam. Also in a case where the terminal receives the RS, with the receive beam formed in an omni-beam when measuring the strength of the RS of the serving base station and target base station, the terminal may determine the optimal transmit beam of each of the serving base station and the target base station. The same description as has been made in connection with FIGS. 3A to 3D applies to the operation of the terminal to form the receive beam for the serving base station and the target base station, and no repetitive description thereof is presented. In operation 710a, the target base station 704 sends a RS, i.e., RS2. The terminal 700 measures the received RS2 in operation 710b. It is assumed that the beam scanning process in the process of measuring RS1 and RS2 performed in operations 708b to 710b is carried out and that a result of measuring the RS of the serving base station 702, the target base station 704, or both the serving base station 702 and the target base station through the beam scanning process in operation 712 meets a handover condition. In this case, the terminal transmits the measurement result to the serving base station 702 through a measurement report message to perform a handover in operation 714. Here, the handover condition corresponds to one of the handover conditions described above in connection with FIG. 1, and no repetitive description thereof is provided.

According to an embodiment of the present disclosure, the time of sending the measurement result message by the terminal is as follows.

First, when a measurement event occurs, if the signal strength of the serving base station is lower than a measurement report threshold (Threshold measurement), the measurement report message is not sent to the serving base station. Here, the measurement report threshold corresponds to the minimum signal strength at which the terminal may transmit a message to the serving base station, e.g., a reference signal received power (RSRP) or received signal strength indicator (RSSI). Accordingly, if the signal strength of the serving base station is lower than the measurement report threshold, the terminal identifies whether the measurement event is maintained for a predetermined time according to an embodiment of the present disclosure. The terminal's identification as to whether the measurement event is maintained for the predetermined time may reduce the number of times at which the terminal does ping-pong that unnecessarily arises due to, e.g., a temporary deterioration of channel status between the serving base station and the target base station. If, upon occurrence of the measurement event, the signal strength of the serving base station is equal or larger than the measurement report threshold, the terminal may be able to transmit a measurement report message to the serving base station, and thus, the terminal immediately sends a measurement report message to the serving base station without no more identification regarding whether the measurement event is maintained.

In a case where the measurement report message from the terminal 700 is successfully transmitted to the serving base station 702, the same process as that described in the embodiment of FIG. 1 proceeds. On the contrary, unless the measurement report message is successfully transmitted to the serving base station 702 as shown in operation 714 or when a measurement event occurs according to an embodiment of the present disclosure—i.e., when the signal strength of the serving base station 702 is lower than the measurement report threshold, the operation may follow that of the embodiment of FIG. 7. Here, the measurement report threshold may be broadcast from the serving base station to the terminal, or the terminal may include the threshold in a user-dedicated message and sent the same upon initial access.

Generally, a base station may independently operate a timer for a radio link failure, and if no sync with the terminal is established until the timer expires, it may declare a radio link failure. However, according to an embodiment of the present disclosure, after the timer for the radio link failure expires, the serving base station 702 starts the handover timer and may declare a radio link failure and handover failure only when failing to a handover request message from the target base station 704 until before the handover timer expires.

It is assumed that the terminal 700 fails to send a measurement report message to the serving base station 702 for a predetermined conditional time. In this case, according to an embodiment of the present disclosure, the terminal 700 may immediately initiate a procedure (random-access procedure) for requesting an uplink resource for transmitting a measurement report message to the target base station 704, or the terminal 700 may immediately transmit a measurement report message to the target base station 704 to request a handover. In other words, the former case is the one where the terminal 700, when sending a measurement report message to the serving base station 702 but failing to receive a signal responsive to the transmission from the serving base station 702 for a predetermined time, sends a measurement report message to the target base station 704, and the latter case is the one where it performs a procedure for sending a measurement report message directly to the target base station 704. In this case, a handover may be carried out as the random-access process starts. The random-access process begins as the terminal 700 transmits a random-access code to the target base station 704 in operation 716. Here, as the random-access code, the HO-Dedicated RACH Preamble received in operation 706b is used. At this time, the terminal 700 may transmit the random-access code using, as the transmit beam ID, the ID of the optimal downlink receive beam that it has previously used upon reception of RS2 from the target base station 704. For example, in a case where the ID of the optimal downlink receive beam is 3 when the terminal measures the reference signal from the target base station, it means that the random-access code is transmitted through a number 3 beam. If the random-access process of the transmission using the beam of the ID of the optimal downlink receive beam fails, the terminal 700 sends the HO-Dedicated RACH Preamble to the target base station 704 using all transmit beams that may transmit the HO-Dedicated RACH Preamble.

According to an embodiment of the present disclosure, if the HO-Dedicated RACH Preamble that the terminal 700 transmits is allocated in a cell-specific manner where it is allocated as a unique value per cell, the terminal includes its identity (MS ID) in the HO-Dedicated RACH Preamble and sends the same. The reason for this is to allow the target base station 704 to identify the HO-Dedicated RACH Preamble of the terminal 700 from HO-Dedicated RACH Preambles received from multiple terminals when receiving the HO-Dedicated RACH Preamble of the terminal 700. According to an embodiment of the present disclosure, upon sending the HO-Dedicated RACH Preamble, the terminal 700 may also include the ID of the optimal transmit beam of the target base station 704 in the downlink that the terminal has measured and send the same. This is why the target base station 704 is unaware of the optimal downlink transmit beam for the terminal 700.

Further, according to an embodiment of the present disclosure, if the HO-Dedicated RACH Preamble that the terminal 700 transmits is allocated in a user-specific manner where a unique value is allocated per terminal, the terminal 700 may include the ID of the optimal transmit beam of the target base station 704 on downlink in the HO-Dedicated RACH Preamble and send the same.

As set forth earlier, the random-access process may include at least one of the process of transmitting the random-access code, the process of transmitting the random-access response message by t8he base station, the process of transmitting TA information to the terminal, and the process of allocating a UL Grant for data transmission. In the embodiment of FIG. 7, it is assumed that the target base station 704 transmits TA information and UL grant to the terminal 700 in operation 718. Here, the UL grant may contain the ID of the optimal transmit beam (UE UL TX Beam ID) of the terminal 700 for uplink. The UL TX Beam ID may be used for transmission of, e.g., a measurement report message in operation 720.

After the above-described random-access process is finished, the terminal 700 sends a measurement report message to the target base station 704 to request a handover in operation 720. The target base station 704, upon completing the reception of the measurement report message from the terminal 700, sends a handover request message to the serving base station 702 in operation 722a. According to an embodiment of the present disclosure, the handover request message may be the same or different in content from the measurement report message transmitted from the terminal 700 to the target base station 704. In operation 722b, the serving base station 702 sends a handover response message to the target base station 704 in response to the handover request message. At this time, the handover response message may contain terminal information (User Context) that the serving base station possesses.

After the target base station 704 receives the handover response message, the target base station 704 sends a handover identify message to the terminal 700 in operation 724a. If the target base station 704 receives a message (HO Confirm OK) responsive to the handover identify message from the terminal 700 in operation 724b, the target base station 704 sends the handover response message of the terminal to the serving base station 702 in operation 724c. Thereafter, the serving base station 702, upon receiving the message responsive to the identification of the handover of the target base station 704, forwards the data of the terminal 700, which the serving base station 702 possesses, to the target base station in operation 726 and terminates the connection with the terminal 700 in operation 728.

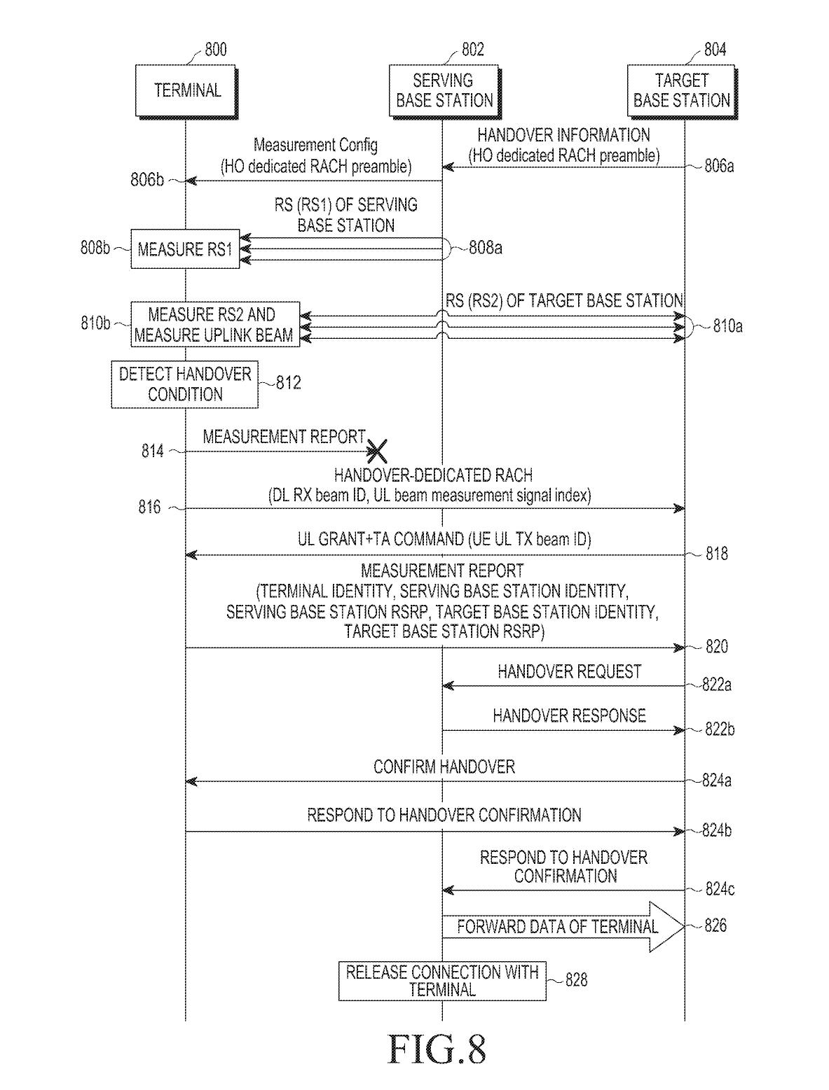

FIG. 8 is a view illustrating another example of a handover process according to an embodiment of the present disclosure.

Referring to FIG. 8, operations 806a and 806b are the same as operations 706a and 706b of FIG. 7, and thus, no repetitive description thereof is made. The terminal 800 linked to the network receives a RS, i.e., RS1, from the serving base station 802 in operation 808a and measures the signal strength of the received RS1 in operation 808b in order to monitor the radio link circumstance. Like in operations 510a and 510b of FIG. 5, the terminal 800, in operations 810a and 810b, performs a measurement process on an uplink beam combination as well as measurement on the RS signal, RS2, received through the downlink of the target base station 804. The beam scanning process and measurement process here are the same as those in the embodiment of FIG. 5, and no repetitive description thereof is given. The downlink transmit beam ID or so is obtained in the random-access code of random-access channel or the beam measurement signal in the measurement process on uplink in operation 810b. The downlink transmit beam ID corresponds to the downlink transmit beam of the target base station 804 having sent the RS with the largest signal strength as chosen through the beam scanning process performed by the terminal on the downlink. Further, the beam measurement signal or the random-access code of random-access channel may also contain the uplink transmit beam ID of the terminal 800 so that the uplink transmit beam may be identified according to an embodiment of the present disclosure. Accordingly, if the uplink beam measurement process is performed, the base station may be able to know the optimal downlink transmit beam for the terminal, which is contained in the beam measurement signal, and it may be aware of the optimal uplink transmit/receive beam by measuring the beam measurement signal, according to an embodiment of the present disclosure.

Further, in order to simplify the uplink beam scanning process, the receive beam of the target base station may be configured and received in the form of an omni-beam, according to an embodiment of the present disclosure. Specifically, the target basement station may determine the optimal uplink transmit beam of the terminal even when receiving the reference signal by constituting the receive beam in the omni-beam form upon measuring the uplink beam measurement signal or random-access code signal for uplink beam measurement. A receive beam combination of the target base station that may be formed when receiving the transmit beam for beam measurement may be configured as shown in FIGS. 6A and 6B. It is assumed that the beam scanning process in the process of measuring RS1 and RS2 performed in operations 808a and 810b is carried out and that a result of measuring the RS of the serving base station 802, the target base station 804, or both the serving base station 802 and the target base station 804 through the beam scanning process in operation 812 detects a handover condition. In this case, the terminal 800 transmits the measurement result to the serving base station 802 through a measurement report message to perform a handover in operation 814. Here, the handover condition corresponds to one of the handover conditions described above in connection with FIG. 1, and no repetitive description thereof is provided. Here, since the time of sending the measurement report message is the same as the time described above in connection with FIG. 7, no repetitive description is presented.

Not shown in FIG. 8, in operation 814, if the measurement report message is successfully transmitted from the terminal 800 to the serving base station 802, the same as that in the embodiment of FIG. 5 is performed. Unless, in operation 814, the measurement report message is successfully transmitted to the serving base station 802 or when a measurement event occurs, and the signal strength of the serving base station is lower than the measurement report threshold, the embodiment of FIG. 8 may apply. Here, the measurement report threshold may be transmitted from the serving base station to the terminal through a broadcast message or through a user-dedicated message when the terminal gains initial access, according to an embodiment of the present disclosure

Meanwhile, a general base station may independently operate a timer for a radio link failure, and unless a sync with the terminal is established until the timer expires, declare a radio link failure. However, according to an embodiment of the present disclosure, after the timer for the radio link failure expires, the handover timer may be initiated and a radio link failure and handover failure may be declared only when the serving base station fails to a handover request message until before the handover timer expires.

It is assumed that the terminal 800 fails to send a measurement report message to the serving base station 802 for a predetermined conditional time. In this case, according to an embodiment of the present disclosure, the terminal 800 may immediately send a handover request message to the target base station 804, or the terminal 800 may directly transmit a measurement report message to the target base station 804 to request a handover. In other words, the former one is the case where the terminal sends a measurement report message to the serving base station, but if it is not transmitted, sends a measurement report message directly to the target base station, and the latter one is to perform a procedure for transmitting a measurement report message directly to the target base station.

In this case, a handover may be carried out as the random-access process starts. The random-access process begins as the terminal 800 transmits a random-access code to the target base station 804 in operation 816. Here, as the random-access code, the HO-Dedicated RACH Preamble received in operation 806b may be used, like in FIG. 7 where it is received in a measurement configuration. The HO-Dedicated RACH Preamble used in the embodiment of FIG. 8 has a different format from the HO-Dedicated RACH Preamble used in the embodiment of FIG. 7.

Specifically, in the embodiment of FIG. 8, if the HO-Dedicated RACH Preamble transmitted from the terminal 800 is allocated in a cell-specific manner, the terminal 800 may include new information in the HO-Dedicated RACH Preamble.

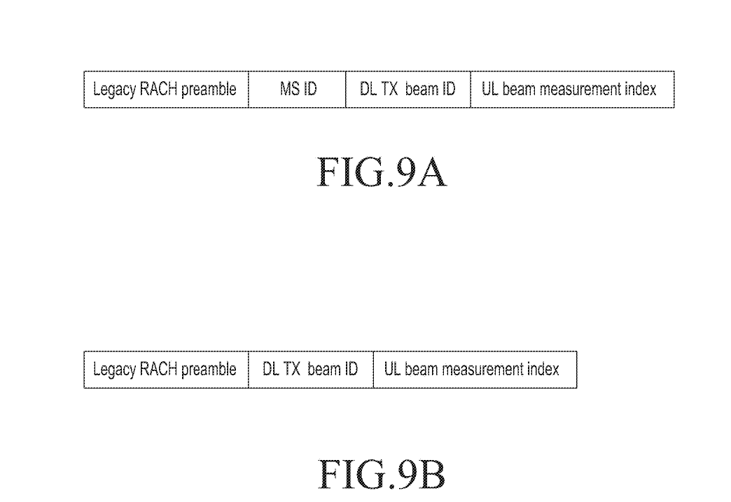

FIG. 9A is a view illustrating an example format of a cell-specific HO-Dedicated RACH preamble according to an embodiment of the present disclosure.

Referring to FIG. 9A, the HO-Dedicated RACH Preamble may include at least one of a MS ID, a DL TX beam ID, and a UL beam measurement index, as well as the existing RACH preamble. First, the MS ID means the identity of the terminal 800, and this may be used as identification information to allow the target base station 804 to identify the HO-Dedicated RACH Preamble of the terminal 800 from HO-Dedicated RACH Preambles received from multiple terminals when receiving the HO-Dedicated RACH Preamble of the terminal 800. The DL TX beam ID denotes the ID of the optimal downlink transmit beam of the target base station 804, and the UL beam sweep index denotes the index of the signal used by the terminal 800 for uplink beam measurement. The UL beam sweep index may be used to inform of the optimal uplink beam when the target base station 804 allocates a UL grant.

In the embodiment of FIG. 8, if the HO-Dedicated RACH Preamble transmitted from the terminal 800 is allocated in a user-specific manner, the terminal 800 may include new information in the HO-Dedicated RACH Preamble.

FIG. 9B is a view illustrating an example format of a user-specific HO-Dedicated RACH preamble according to an embodiment of the present disclosure.

Referring to FIG. 9B, the HO-Dedicated RACH Preamble may contain not only the existing legacy RACH preamble but also a DL TX beam ID and UL beam sweep index. The definition of the DL TX beam and the UL beam sweep index is the same as that described above, and no description thereof is provided.

In operation 816, e.g., when the terminal 800 sends a HO-Dedicated RACH Preamble to the target base station 804, the terminal 800 may use, as a transmit beam, the DL Target BS RX Beam ID that it has used when receiving RS2 from the target base station 804 or the optimal uplink transmit beam information (UL UE TX Beam ID) that it has obtained in the uplink beam scanning process. If the RACH process of the transmission using the DL Target BS RX Beam ID or UL UE TX Beam ID fails, the terminal 800 sends the HO-Dedicated RACH Preamble to the target base station 804 using all transmit beams that may transmit the HO-Dedicated RACH Preamble.

It is assumed in the embodiment of FIG. 8 that the UL grant and TA are transmitted to the target base station 804 as in operation 818 of the above-described random access process. Here, the UL Grant may contain the UL TX Beam ID of the terminal 800 obtained from the HO-Dedicated RACH Preamble. This is why the target base station 804 already knows the optimal uplink transmit beam of the terminal having sent the UL beam measurement signal in the downlink/uplink beam scanning process before handover based on the received UL beam measurement signal index. According to an embodiment of the present disclosure, the UL TX Beam ID of the terminal 800 may be used for transmission of, e.g., a measurement report message.

After the random-access process is finished, the terminal 800 sends a measurement report message to the target base station 804 to request a handover in operation 820. Here, the measurement report message includes the identity of the terminal 800, the identity of the serving base station 802, the RSRP of the serving base station, the identity of the target base station 804, and the RSRP of the target base station. The target base station 804, after completing the reception of the measurement report message from the terminal, sends a handover request message to the serving base station 802 in operation 822a. According to an embodiment of the present disclosure, the handover request message may be the same or different in content from the measurement report message transmitted from the terminal 800 to the target base station 804. In operation 822b, the serving base station 802 sends a handover response message to the target base station 804 in response to the handover request message. At this time, the handover response message may contain a User Context that the serving base station possesses. The subsequent operations 824a, 824b, 824c, 826, and 828 are the same as operations 724a, 724b, 724c, 726, and 728 of FIG. 7, and no repetitive description thereof is thus given.

Meanwhile, according to an embodiment of the present disclosure, in a case where the terminal detects a handover condition, if the detected handover condition corresponds to handover condition 3 of the above-enumerated handover conditions, it identifies whether the current situation has occurred due to a temporary channel variation and identifies whether the detection of the handover condition is maintained for a predetermined time (Time to Trigger (TTT)). Specifically, according to an embodiment of the present disclosure, if the terminal identifies the start condition of handover condition 3 above, i.e., the signal strength (Mn) of RS2 of the target base station is larger than the sum of the signal strength (Ms) of RS1 of the serving base station, the offset (off), and the tolerance value (Hys) (Mn>Ms+off+Hys), the terminal starts the TTT at a time interval corresponding to the start condition.

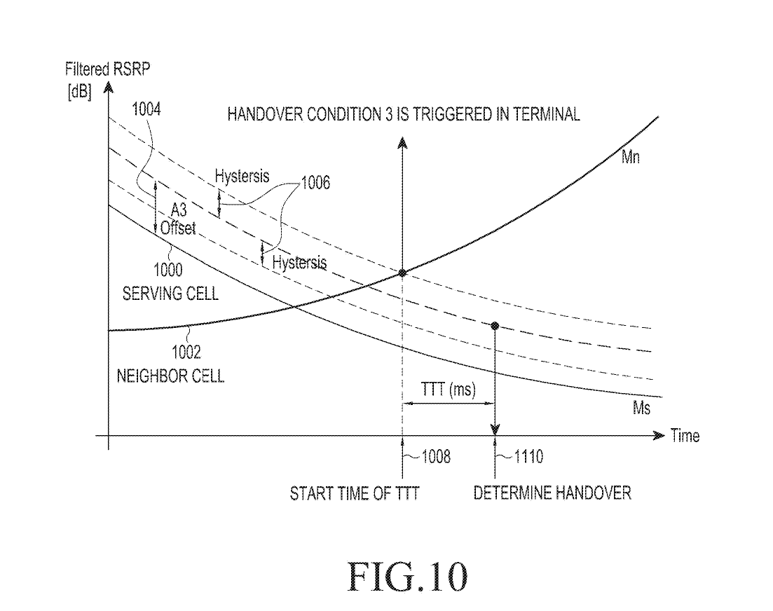

FIG. 10 is a view illustrating an example of a handover condition detection interval according to an embodiment of the present disclosure.

Referring to FIG. 10, the X-axis denotes the time axis, and the Y-axis denotes the RSRP corresponding to the time. In the graph of FIG. 10, as time passes by, the signal strength (Mn, 1002) of a neighbor cell corresponding to the signal strength of RS2 of the target base station which is measured by the terminal gradually increases, and the signal strength (Ms, 1000) of the serving cell corresponding to the signal strength of RS1 of the serving base station gradually decreases.

Since the signal strength Mn of the neighbor cell is the same as the sum of the signal strength Ms of RS1, the offset A3 (off, 1004), and the tolerance value (Hys, 1006) during the time interval corresponding to reference numeral 1008, the terminal starts the TTT at the time interval corresponding to reference numeral 1008. According to an embodiment of the present disclosure, if the condition where the signal strength Mn of the neighbor cell is larger than the sum of the signal strength Ms of RS1, the offset (off, 1004), and the tolerance value (Hys, 1006) is maintained during the TTT, the terminal determines to perform a handover. In the graph of FIG. 10, since reference numeral 1110 corresponds to the termination interval of the TTT, the terminal terminates the TTT at the time interval corresponding to reference numeral 1110 and determines to perform a handover.

Meanwhile, the terminal may have a relative movement speed different as per the movement of the user. If the TTT is set as a fixed value, the terminal having a relatively high movement speed might not be subject to such a measurement and determination as the one made as long as the original TTT because it moves fast, and thus, it requires a quick judgment to determine a handover. Thus, it makes a determination for a relatively short TTT, and if a handover condition is detected, performs a handover. Therefore, the TTT value needs to be flexibly adjusted given the mobility of the terminal. According to an embodiment of the present disclosure, there is proposed a scheme for flexibly adjusting the TTT considering the movement speed of the terminal.

Specifically, according to an embodiment of the present disclosure, the terminal's mobility may be detected by the following method, and a weight corresponding to the detected speed may be applied to the TTT. First, in order to detect whether the terminal's movement speed is high, at least two references may be set based on the number of times of the reselection of the terminal, according to an embodiment of the present disclosure. As an example, it is assumed to detect whether the terminal's current movement speed is a high speed or medium speed based on the two references. To that end, the two references may contain a maximum threshold and medium threshold of the number of times of cell reselection. The terminal identifies the number of times of the reselection of the terminal during a preset time interval. If the number of times of the cell reselection of the moving terminal as measured during the time interval exceeds the medium threshold and not higher than the maximum threshold, the terminal's current movement speed is determined to be the medium speed. In this case, the terminal may increase the TTT by applying a medium weight factor set to be larger than 1 to a current default TTT.

If the number of times of the cell reselection of the moving terminal as measured during the time interval exceeds the maximum threshold, the terminal may determine that its current speed is the high speed. In this case, the terminal may reduce the TTT by applying a maximum weight factor of the TTT set to be smaller than one to the default TTT.

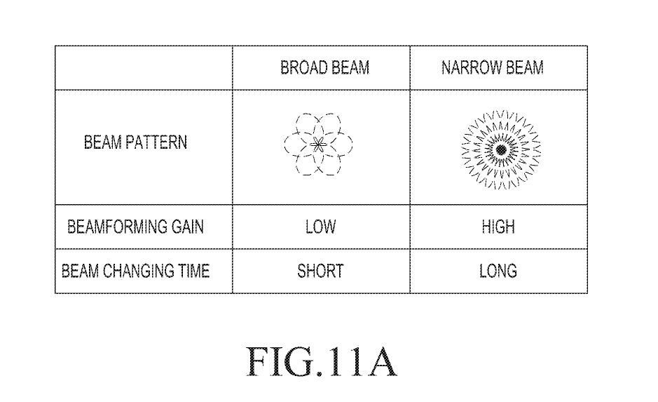

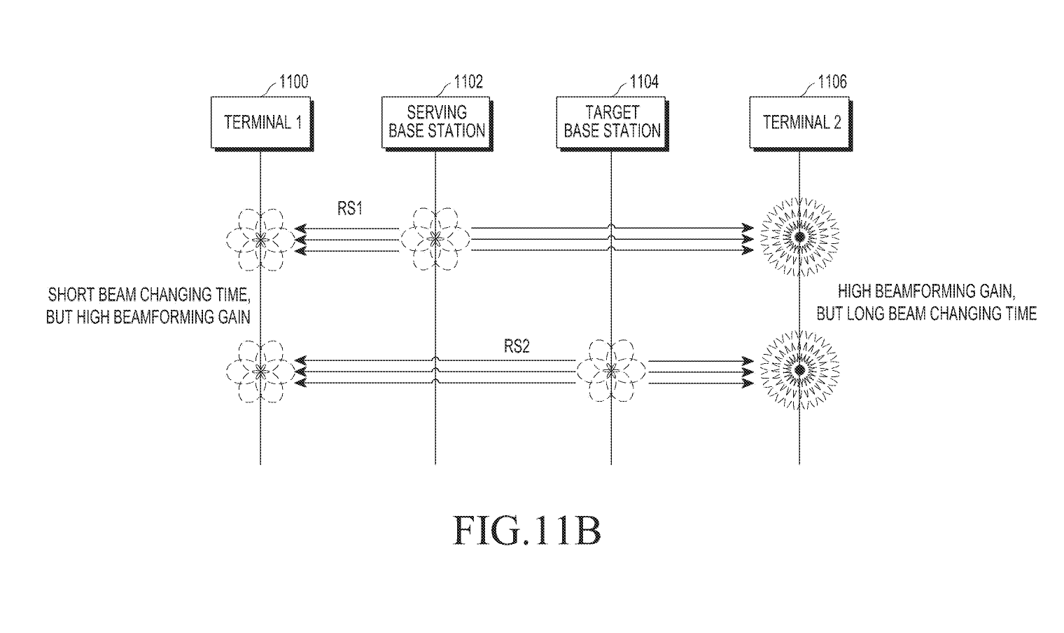

FIG. 11A is a table illustrating examples of a beam pattern and beam change time as per the number of beams possessed by a terminal according to an embodiment of the present disclosure.

Referring to FIG. 11A, if the number of beams possessed by the terminal is relatively small, e.g., if the number is smaller than a predetermined threshold, the beam pattern forms a broader beam than each beam of the terminal possessing a larger number of beams than the threshold. By comparison, for a terminal having a larger number of beams than the threshold, the beam pattern is narrowed relative to the broader beam. Resultantly, the terminal having the broader beam has less transmission accuracy for the corresponding direction as compared with the terminal having the narrower beam and thus has a reduced beamforming gain. In contrast, the smaller number of beams presents the advantage that the beam switching time is relatively short in the beam scanning process. In comparison, the terminal having the narrower beam has a high beamforming gain thanks to an increase in the transmission accuracy for the corresponding direction while suffering from a relatively long beam switching time in the beam scanning process due to the larger number of beams.

FIG. 11B is a flowchart illustrating an example of signal transmit/receive operations of a terminal having a broad beam pattern and a terminal having a narrow beam pattern according to an embodiment of the present disclosure.

Referring to FIG. 11B, terminal 1 1100, because it performs a beam scanning process using a broad beam pattern upon receiving RS1 from the serving base station 1102 and RS2 from the target base station 1104, happens to have a low beamforming gain and a short beam switching time as compared with terminal 2 1106. Since terminal 2 1106 performs a beam scanning process using a narrow beam pattern upon receiving RS1 and RS1 respectively from the same serving base station 1102 and target base station 1104, terminal 2 1106 happens to have a long beam switching time but a high beamforming gain as compared with terminal 1 1100.

Hence, according to an embodiment of the present disclosure, as described in connection with FIGS. 11A and 11B, there is proposed a scheme for adaptively switching the default TTT value using the advantages and disadvantages of each beam pattern.

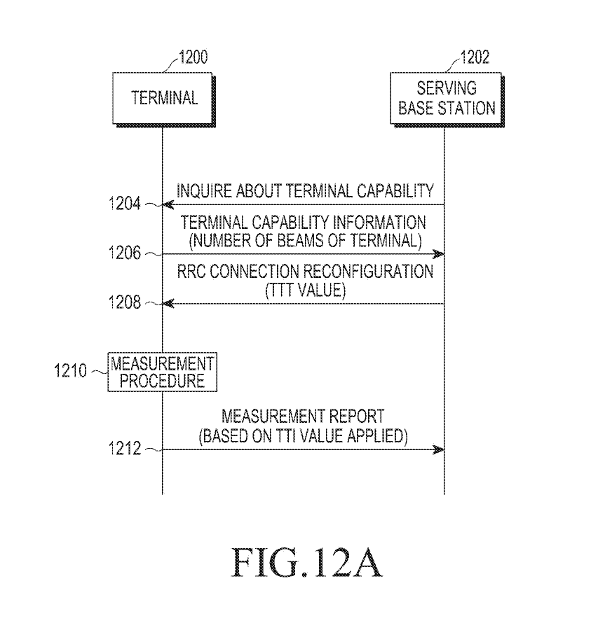

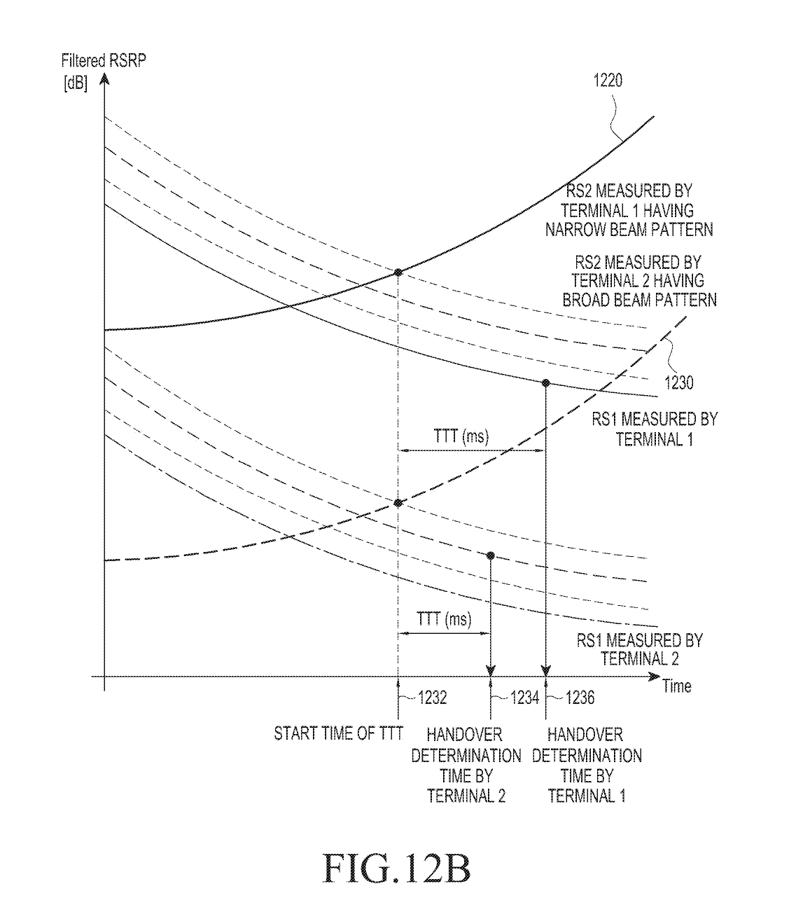

FIG. 12A is a flowchart illustrating an example of operations for adjusting a TTT value corresponding to the number of beams of a terminal according to an embodiment of the present disclosure.

Referring to FIG. 12A, as an example, if the serving base station 1202 detects the initial access of the terminal 1200, it sends a capability inquiry message to the terminal 1200 to inquire about the number of beams the terminal possesses in operation 1204. Then, in operation 1206, the terminal 1200 transmits terminal capability information containing the number of beams the terminal has to the serving base station 1202. Then, the serving base station 1202 may identify the number of beams of the terminal 1200 contained in the terminal capability information and reset the TTT value based on the identified number of beams.

FIG. 12B is a view illustrating an example of a TTT varying depending on beam patterns of a terminal according to an embodiment of the present disclosure.

Referring to FIG. 12B, such a case is assumed, for ease of description, where the beams of terminal 1 are more than the beams of terminal 2 and thus terminal 1 forms a narrower beam pattern while terminal 2 forms a broader beam pattern. Like in the graph (i.e. graph lines 1220 and 1230) shown in FIG. 10, as time elapses, the signal strengths of RS1 transmitted from the serving base station, which are respectively measured by terminal 1 and terminal 2, decrease, and the signal strength of RS2 transmitted from the target base station increases. For ease of description, it is assumed that terminal 1 and terminal 2 meet the start interval of the TTT as described above in the same time interval corresponding to reference numeral 1232. Since the number of beams of terminal 2 is larger than the number of beams of terminal 1, the beam scanning process takes a relatively longer time. Accordingly, the TTT of terminal 1 terminates in the time interval corresponding to reference numeral 1234 whereas the TTT of terminal 2 terminates in the time interval corresponding to reference numeral 1236 which is a time interval coming after the time interval corresponding to reference numeral 1234. Hence, where the obtained number of beams of the terminal 1200 is larger than a threshold, the serving base station 1202, in operation 1208, may select a weight factor larger than 1, e.g., in order to increase the default TTT. If the number of beams of the terminal 1200 is equal or smaller than the threshold number of beams, a weight factor smaller than 1 may be selected to reduce the default TTT. As another example, the threshold number of beams may be operated to be two or more. It is assumed that the threshold number of beams is three. In this case, the serving base station 1202 may select a weight factor corresponding to the threshold by which the default TTT may stepwise be adjusted per threshold. For example, it is assumed that threshold 1 and threshold 3 are present, and the threshold 1 is the largest number. At this time, if the number of beams of the terminal 1200 is larger than threshold 1, the default TTT may be multiplied with a first weight factor to be increased as much as operation 1. Next, if the number of beams of the terminal 1200 is equal or larger than threshold 2 and smaller than threshold 1, the serving base station 1202 may multiply the default TTT by a second threshold to increase the default TTT as much as operation 2 which is smaller than the operation 1-increased default TTT. If the number of beams of the terminal 1200 is equal or larger than threshold 3 and smaller than threshold 2, the serving base station 1202 may multiply the default TTT by a third threshold to increase the default TTT as much as operation 3 which is smaller than the operation 2-increased default TTT. Last, for being equal or smaller than threshold 3, the serving base station 1202 may maintain the default TTT.

According to an embodiment of the present disclosure, the serving base station 1202 delivers information about the weight factor or weight factor-applied TTT value to the terminal 1200 in operation 1208. At this time, the information about the weight factor and the weight factor-applied TTT value may be included and transferred in, e.g., a RRC connection reconfiguration message. Thereafter, if the terminal 1200 receives the RRC connection reconfiguration message to obtain the information about the weight factor or the weight factor-applied TTT value in operation 1210, the terminal 1200 performs measurement on RS1 transmitted from the serving base station 1202, and the terminal 1200 transmits a measurement result to the serving base station 1202 in operation 1212. Although the measurement procedure according to the embodiment of FIG. 12 focuses only on the description of the serving base station 1202 for ease of description, the terminal 1200 performs measurement on RS2 based on the information about the weight factor or weight factor-applied TTT value also for the target base station. In other words, the terminal determines a handover start condition by applying the information about the weight factor or weight factor-applied TTT to R1 and R2 received from the serving base station and the target base station. According to the present disclosure, the terminal and the base station have a plurality of beams. For example, assuming that the base station has M beams and the terminal has N beams, the terminal may have M×N beam measurement results. Accordingly, since the measurement procedure encompasses multiple beam pair measurement results in the TTT, the terminal may report the maximum one of measurement results per measurement procedure performed within the TTT interval, report a mean value of signal strengths corresponding to a predetermined number, or report a mean value of all signal strengths according to embodiments.

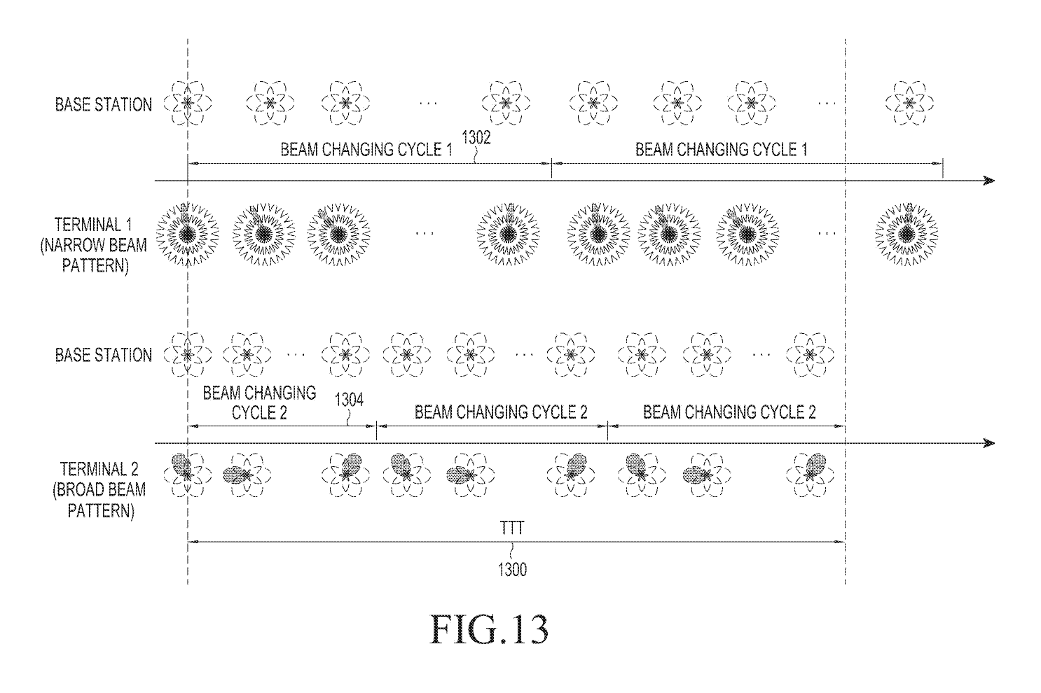

FIG. 13 is a view illustrating an example of the number of times in which a beam scanning is performed as per the number of beams of a terminal during a TTT according to an embodiment of the present disclosure.

Referring to FIG. 13, it is assumed, for ease of description, that terminal 1 has a large number of beams and thus a narrow beam patter whereas terminal 2 has a relatively smaller number of beams than does terminal 2 and resultantly a broad beam pattern. In this case, since terminal 1 has beam switching cycle 1 1302 corresponding to the number of beams for RSs transmitted from the same base stations in the default TTT 1300, it performs one beam scanning operation and a partial beam scanning operation. By comparison, terminal 2 performs three beam scanning operations in total in the TTT 1300 as beam switching cycle 2 1304 corresponding to the number of beams is shorter than beam switching cycle 1 1302. Thus, according to an embodiment of the present disclosure, the number of RSs whose signal strength is to be measured in the default TTT may be selected by the terminal according to the beam pattern. For example, where a terminal uses a relatively narrow beam pattern, the terminal may perform measurement for a predetermined number of RSs instead of measuring the strength of RSs received through all the beams in the default TTI. It may determine a handover condition based on the measured strength of the selected RSs. According to another embodiment, the TTT may be adjusted considering at least one or both of the movement speed and beam pattern of the terminal.

In another embodiment, a terminal having many receive beams may determine a handover condition by setting a value larger than the default TTT to the TTT to perform measurement for a relatively long time, and a terminal having a smaller number of receive beams may determine a handover condition by setting the default value or a value smaller than the default value to the TTT to perform measurement for a relatively short time.

Meanwhile, according to another embodiment of the present disclosure, there is proposed a scheme for performing measurement on a terminal that may gain access to two or more base stations supportive of different frequency bands. For ease of description, it is assumed that the terminal may access base station 1 supporting a 2 Ghz frequency band and base station 2 supporting a 28 GHz frequency band. In this case, according to an embodiment of the present disclosure, there is proposed a way for applying different measurement reporting schemes according to the frequency bands supported by the serving base station and the target base station when the terminal hands over.

Table 1 shows an example of a measurement report type of a terminal where the serving frequency bands of the serving base station and the target base station differ, according to an embodiment of the present disclosure.

TABLE 1

| Frequency band (carrier | Frequency band (carrier | |
|---|---|---|
| type) of serving | type) of target | Measurement report |
| base station | base station | type |
| 2 GHz | 2 GHz | Type 1 |
| 2 GHz | 28 GHz | Type 1 |
| 28 GHz | 2 GHz | Type 2 |
| 28 GHz | 28 GHz | Type 2 |

Referring to Table 1, the base station supportive of the 2 GHz frequency band may support legacy operations regardless of whether the target base station supports an ultra-high frequency band. In contrast, a terminal attached to a base station supportive of an ultra-high frequency band, e.g., 28 GHz, is typically put in the position of having difficulty in communicating with the serving base station at the time a handover condition is detected. Hence, according to an embodiment of the present disclosure, if the serving base station supports an ultra-high frequency band, the terminal may send a measurement report to the target base station regardless of the frequency band supported by the target base station. Or, according to an embodiment of the present disclosure, after the terminal sends a measurement result to the serving base station, if it fails to receive a response to the measurement result from the serving base station within a predetermined time, the terminal may directly send the measurement report to the target base station. Specifically, according to an embodiment of the present disclosure, the measurement report type of the terminal is chosen and applied depending on the frequency band supported by the serving base station. That is, if the serving base station of the terminal supports 2 GHz, the terminal performs a measurement report corresponding to type 1, and if the serving base station supports an ultra-high frequency band, the terminal performs a measurement report corresponding to type 2. Type 1 is a scheme in which the terminal transmits a measurement report to the serving base station according to a normal measurement report scheme, and type 2 is a scheme in which the terminal transmits a measurement report to the target base station.

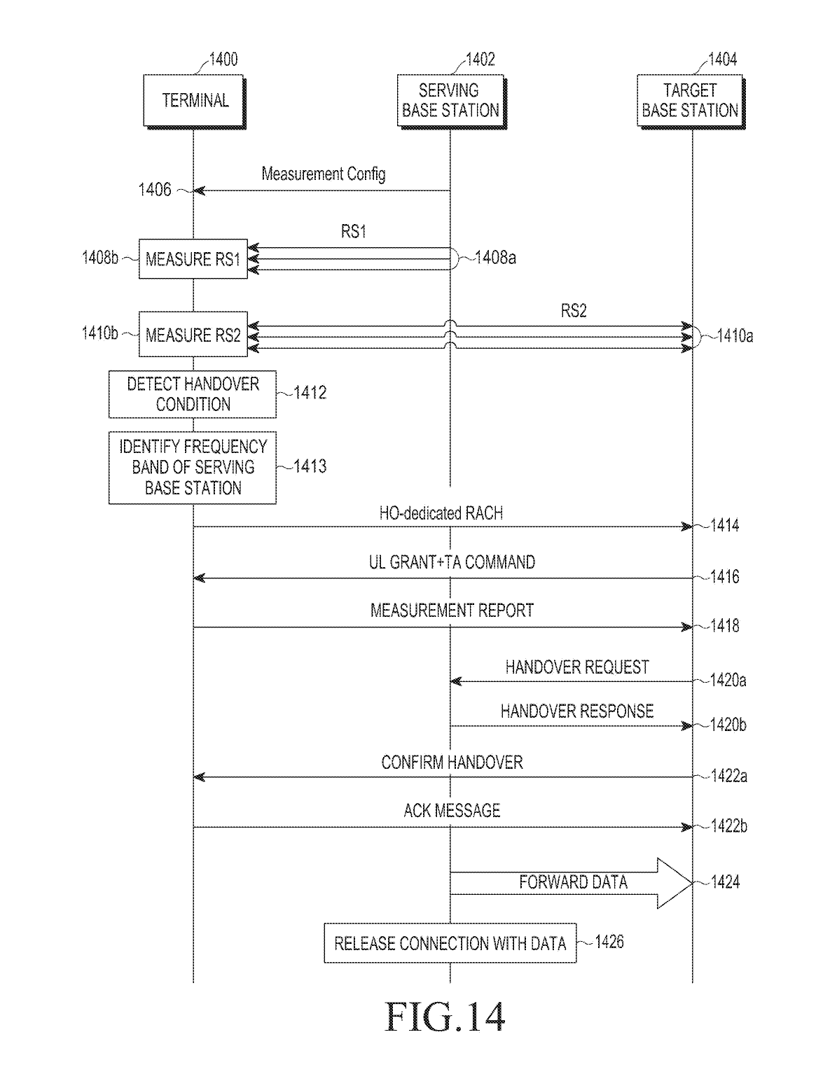

FIG. 14 is a flowchart illustrating an example of handover operations including an operation for performing a measurement report as per a frequency band supported by a serving base station according to an embodiment of the present disclosure.

Referring to FIG. 14, operations 1406 to 1412 are operated in the same manner as the operations of FIGS. 1, 2A, 2B, 3A to 3D, 4A, 4B, 5, 6A, 6B and 7 as set forth above, and no repetitive description thereof is given. In operation 1412, if the terminal 1400 detects a handover condition, the terminal 1400 identifies a frequency band supported by the serving base station 1402 in operation 1413. Where, as a result of the identification, the serving base station 1402 supports an ultra-high frequency band, e.g., 28 GHz, the terminal is operated in type 2 that transmits a measurement report to the target base station 1404 rather than in type 2 where the terminal normally transmits a measurement report to the serving base station 1402. Therefore, the terminal 1400, in operation 1418, delivers a measurement result obtained according to the beam scanning procedure performed in operations 1408b to 1410b directly to the target base station 1404, not the serving base station 1402. Other operations of FIG. 14 are the same as those in the previous embodiments and no repetitive description thereof is provided.

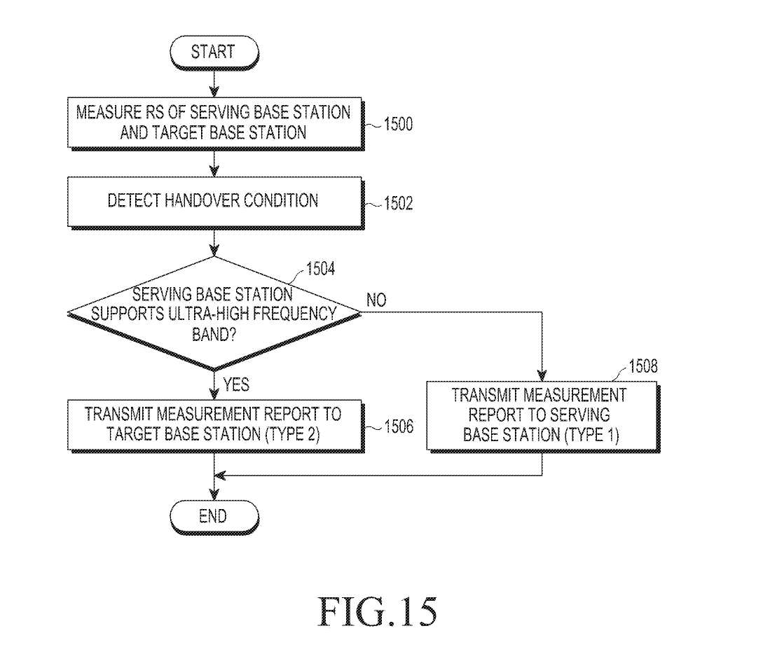

FIG. 15 is a flowchart illustrating an example of operations by a terminal according to the embodiment shown in FIG. 14.

Referring to FIG. 15, in operation 1500, the terminal measures the strength of RSs respectively transmitted from the serving base station and the target base station. Here, since the measurement procedure is the same as those in the above-described embodiments, no repetitive description is presented. In operation 1502, the terminal identifies whether one of the above-described handover conditions is met based on the result obtained through the measurement procedure, and upon detecting that one handover is satisfied, the terminal proceeds with operation 1504. In operation 1504, the terminal identifies whether the frequency band supported by the serving base station is an ultra-high frequency band. Where a result of the identification reveals that it supports an ultra-high frequency band, the terminal is operated in type 2 to transmit the measurement result to the target base station in operation 1506. Where a result of the identification reveals that it supports a frequency band other than an ultra-high frequency band, the terminal is operated in type 1 to transmit the measurement result to the serving base station in operation 1508. For ease of description, such a case has been described in connection with the embodiments of FIGS. 14 to 15 where the terminal, if attaching to the serving base station supportive of an ultra-high frequency band, directly transmits the measurement result to the target base station after detecting a handover condition. According to another embodiment, however, the terminal, after detecting a handover condition, may first send the measurement result to the serving base station, and upon failure to receive a response to the measurement result from the serving base station, may directly send the measurement result to the target base station.

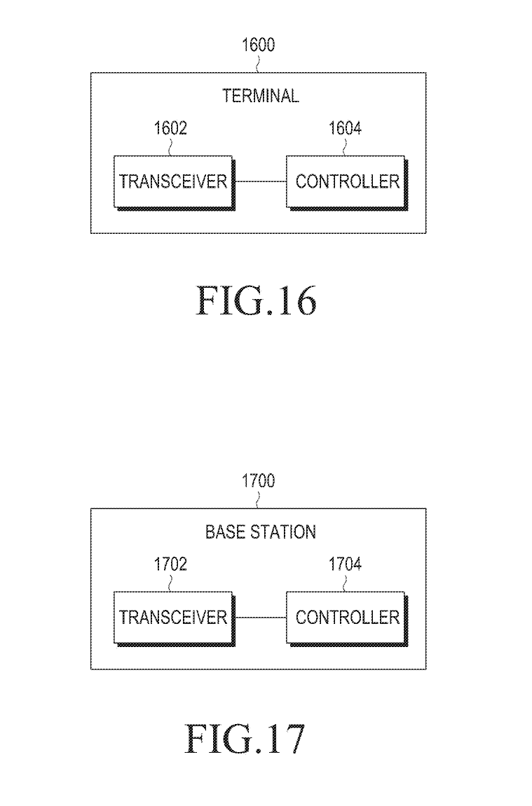

FIG. 16 is a view illustrating an example of a configuration of a terminal according to an embodiment of the present disclosure.

Referring to FIG. 16, the terminal 1600 may include, e.g., a transceiver 1602 and a controller 1604. The controller 1604 controls the overall of the terminal for a handover according to an embodiment of the present disclosure as set forth above. The transceiver 1602 transmits and receives signals according to instructions of the controller 1604.

FIG. 17 is a view illustrating an example of a configuration of a base station according to an embodiment of the present disclosure.

Referring to FIG. 17, the base station 1700 may include, e.g., a transceiver 1702 and a controller 1704. Here, the base station 1700 may operate as a serving base station or target base station according to an embodiment of the present disclosure. The controller 1704 controls the overall of the serving base station or target base station for a handover according to an embodiment of the present disclosure as set forth above. The transceiver 1702 transmits and receives signals according to instructions of the controller 1704.

Particular aspects of the present disclosure may be implemented in computer-readable codes on a computer-readable recording medium. The computer readable recording medium is a data storage device that may store data readable by a computer system. Examples of the computer readable recording medium may include read only memories (ROMs), random-access memories (RAMs), compact disk-read only memories (CD-ROMs), magnetic tapes, floppy disks, optical data storage devices, and carrier waves (such as data transmission over the Internet). The computer readable recording medium may be distributed by computer systems over a network, and accordingly, the computer readable codes may be stored and executed in a distributed manner. Functional programs, codes, and code segments to attain the present disclosure may be readily interpreted by skilled programmers in the art to which the present disclosure pertains.

The apparatuses and methods according to embodiments of the present disclosure may be implemented in hardware, software, or a combination of hardware and software. Such software may be recorded in volatile or non-volatile storage devices, such as ROMs, memories, such as RAMs, memory chips, memory devices, or integrated circuit devices, compact discs (CDs), DVDs, magnetic disks, magnetic tapes, or other optical or magnetic storage devices while retained in machine (e.g., computer)-readable storage media. The methods according to embodiments of the present disclosure may be implemented by a computer or a portable terminal including a controller and a memory, and the memory may be a machine-readable storage medium that may properly retain program(s) containing instructions for implementing the embodiments of the present disclosure.

Accordingly, the present disclosure encompasses a program containing codes for implementing the device or method set forth in the claims of this disclosure and a machine (e.g., computer)-readable storage medium storing the program. The program may be electronically transferred via any media such as communication signals transmitted through a wired or wireless connection and the present disclosure properly includes the equivalents thereof.

The apparatuses according to embodiments of the present disclosure may receive the program from a program providing device wiredly or wirelessly connected thereto and store the same. The program providing apparatus may include a memory for storing a program including instructions enabling a program processing apparatus to perform a method according to an embodiment of the present disclosure and data necessary for a method according to an embodiment of the present disclosure, a communication unit for performing wired or wireless communication with a graphic processing apparatus, and a controller transmitting the program to the graphic processing apparatus automatically or as requested by the graphic processing apparatus.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1.-15. (canceled)

16. A method for a handover by a terminal in a communication system using beamforming, the method comprising:
receiving, from a serving base station, handover identification information related to at least one neighbor base station;
measuring a reference signal of the serving base station and a reference signal of a target base station comprising the at least one neighbor base station, based on beam scanning;
transmitting a handover request message comprising handover information to the serving base station if a result of the measuring meets a handover condition;
receiving, from the target base station, a handover admittance message; and
if a handover identifier obtained from the handover admittance message comprises a handover identifier of the target base station identified from the received handover identification information, performing an access procedure with the target base station.

17. The method of claim 16, wherein the handover identification information of the target base station comprises a unique identifier allocated to the target base station or a unique identifier allocated to the terminal among a plurality of identities allocated to the target base station.

18. The method of claim 16, wherein the handover information comprises:
at least one of an identifier and a transmission beam index for the target base station selected from the neighbor base station based on the result of the measuring, and
an identifier of the terminal.

19. The method of claim 16, further comprising:
if an acknowledge message for the handover request message is received from the serving base station, stopping a connection established with the serving base station, and
performing a downlink synchronization procedure with the target base station.

20. The method of claim 16, further comprising:
obtaining timer information for the handover from the handover admittance message;
starting a timer based on the timer information;
if the access procedure is completed, determining whether the timer is expired; and
if the timer is running, transmitting a handover completion message to the target base station.

21. A method for supporting a handover of a terminal by a target base station in a communication system using beamforming, the method comprising:
transmitting, to a serving base station, a handover identifier of the target base station;
transmitting a reference signal;
receiving, form the serving base station, a handover request message;
obtaining handover information from the handover request message; and
transmitting, to the terminal, a handover admittance message comprising the handover identifier of the target base station based on the handover information.

22. The method of claim 21, wherein the handover identifier includes handover identification information of the target base station comprising a unique identifier allocated to the target base station or a unique identifier allocated to the terminal among a plurality of identities allocated to the target base station.

23. The method of claim 21, wherein the handover information comprises:
at least one of an identifier and a transmission beam index for the target base station, and
an identifier of the terminal.

24. The method of claim 21, further comprising:
after transmitting the handover admittance message, starting a timer for the handover corresponding to timer information included in the handover admittance message;
if a handover completion message is received from the terminal, determining whether the timer is expired;
if the timer is running, transmitting, to the serving base station, the handover completion message.

25. The method of claim 21, wherein the handover admittance message is transmitted using a transmission corresponding to a transmission beam index obtained from the handover information.

26. A terminal for a handover in a communication system using beamforming, the terminal comprising:
a transceiver configured to receive, from a serving base station, handover identification information related to at least one neighbor base station; and
at least one processor configured to:
measure a reference signal of the serving base station and a reference signal of a target base station comprising the at least one neighbor base station, based on beam scanning,
if a result of the measuring meets a handover condition, control the transceiver to transmit a handover request message comprising handover information to the serving base station,
obtain a handover identifier from a handover admittance message received from the target base station,
if the obtained handover identifier is a handover identifier of the target base station, identify the handover identifier of the target base station from the received handover identification information, and
perform an access procedure with the target base station.

27. The terminal of claim 26, wherein the handover identification information of the target base station comprises a unique identifier allocated to the target base station or a unique identifier allocated to the terminal among a plurality of identities allocated to the target base station.

28. The terminal of claim 26, wherein the handover information comprises:
at least one of an identifier and a transmission beam index for the target base station selected from the neighbor base station based on the result, and
an identifier of the terminal.

29. The terminal of claim 26, wherein, if an acknowledge message for the handover request message is received from the serving base station, the at least one processor is further configured to;
stop a connection established with the serving base station, and
perform a downlink synchronization procedure with the target base station.

30. The terminal of claim 26, wherein the at least one processor is further configured to:
obtain timer information for the handover from the handover admittance message,
start a timer based on the timer information,
if the access procedure is completed, determine whether the timer is expired, and
if the timer is running, control the transceiver to transmit a handover completion message to the target base station.

31. A target base station for supporting a handover of a terminal in a communication system using beamforming, the target base station comprising:
a transceiver configured to transmit, to a serving base station, a handover identifier of the target base station, and transmit a reference signal; and
at least one processor configured to:
if a handover request message is received from the serving base station, obtain handover information from the handover request message, and
control the transceiver to transmit, to the terminal, a handover admittance message comprising the handover identifier of the target base station based on the handover information.

32. The target base station of claim 31, wherein the handover identification information of the target base station comprises a unique identifier allocated to the target base station or a unique identifier allocated to the terminal among a plurality of identities allocated to the target base station.

33. The target base station of claim 31, wherein the handover information comprises:
at least one of an identifier and a transmission beam index for the target base station, and
an identifier of the terminal.

34. The target base station of claim 31, wherein, after the transmitting of the handover admittance message, the at least one processor is further configured to:
start a timer for the handover corresponding to timer information included in the handover admittance message,
if a handover completion message is received from the terminal, determine whether the timer is expired, and
if the timer is running, control the transceiver to transmit, to the serving base station, the handover completion message.

35. The target base station of claim 31, wherein the transceiver is configured to transmit the handover admittance message using a transmission corresponding to a transmission beam index obtained from the handover information.

36. The target base station of claim 31, wherein the target base station is configured to receive a measurement from the terminal.
